(19) United States
(12) Patent Application Publication
(10) Pub. No.: US 2023/0091792 A1
(43) Pub. Date: Mar. 23, 2023

(54) MEMORY SYSTEM AND METHOD OF CONTROLLING NONVOLATILE MEMORY

(71) Applicant: Kioxia Corporation, Tokyo (JP)

(72) Inventor: Shinichi KANNO, Ota (JP)

(73) Assignee: Kioxia Corporation, Tokyo (JP)

(21) Appl. No.: 17/653,916

(22) Filed: Mar. 8, 2022

(30) Foreign Application Priority Data
Sep. 17, 2021 (JP) 2021-152009

(51) Int. Cl. G06F 3/06

(52) U.S. Cl. CPC G06F 3/0659; G06F 3/0608; G06F 3/0652; G06F 3/0679

(57) ABSTRACT

According to one embodiment, when a total size of write data associated with one or more received write commands which specify one write destination block reaches a first write size, a controller executes a write operation for the one write destination block such that writing of write data having a first minimum write size to the one write destination block is completed, the write data having the first minimum write size being among pieces of write data stored in a write buffer of a memory included in a host. When a remaining capacity of the write buffer falls below a threshold, the controller writes, to a second block, write data corresponding to the selected write destination block, and causes the host to release a region of the write buffer storing the write data written to the second block.

### CROSS-REFERENCE TO RELATED APPLICATIONS

This application is based upon and claims the benefit of priority from Japanese Patent Application No. 2021-152009, filed Sep. 17, 2021, the entire contents of which are incorporated herein by reference.

### FIELD

Embodiments described herein relate generally to a technique for controlling a nonvolatile memory.

### BACKGROUND

In recent years, memory systems implemented with nonvolatile memories have been widely used. As one of such memory systems, a solid state drive (SSD) implemented with a NAND flash memory is known. The SSD is used as a storage device of a host computing system such as a server in a data center.

In the storage device used in the host computing system, such as the server, it is necessary to write different pieces of data to different write destination blocks of a nonvolatile memory in some cases. In order to cope with such a need, it is conceivable to use each of several blocks among blocks included in the nonvolatile memory as a nonvolatile write buffer for temporarily storing pieces of data that are to be written to different write destination blocks.

In this case, if processing of writing all the pieces of data to the individual write destination blocks through the nonvolatile write buffer is executed, the number of required nonvolatile write buffers is increased.

Therefore, there is a demand for implementation of a new technique capable of efficiently writing data to a plurality of write destination blocks without increasing the size of nonvolatile write buffers required to be prepared in a memory system.

### BRIEF DESCRIPTION OF THE DRAWINGS

FIG. 1 is a block diagram illustrating an example of a configuration of an information processing system including a memory system according to an embodiment.

FIG. 2 is a block diagram illustrating an example of a configuration of a host and an example of a configuration of the memory system according to the embodiment.

FIG. 3 is a block diagram illustrating a plurality of quad-level cell blocks (QLC blocks) used as storage regions for user data and a plurality of pseudo single-level cell blocks (pSLC blocks) used as pseudo single-level cell buffers (pSLC buffers).

FIG. 4 is a block diagram illustrating a relationship between a plurality of channels and a plurality of NAND flash memory dies used in the memory system according to the embodiment.

FIG. 5 is a diagram illustrating an example of a configuration of a certain block group (super block) used in the memory system according to the embodiment.

FIG. 6 is a diagram for describing a multi-step write operation applied to a QLC block.

FIG. 7 is a diagram illustrating an example of a configuration of a zoned namespace defined by a standard of NVMe.

FIG. 8 is a diagram illustrating an operation of updating a write pointer executed in the memory system according to the embodiment.

FIG. 9 is a diagram illustrating an example of a configuration of a management table that is used in the memory system according to the embodiment and stores a correspondence relationship between each of a plurality of zones and each of a plurality of QLC blocks.

FIG. 10 is a diagram illustrating an operation of managing a plurality of write commands received from the host, the operation being executed in the memory system according to the embodiment.

FIG. 11 is a diagram illustrating a write operation for a QLC block and an operation of transmitting a completion response to the host and releasing a region in a host write buffer, the operations being executed in the memory system according to the embodiment.

FIG. 12 is a diagram illustrating an operation of selecting a QLC block in which a total size of write date to be written thereto, stored in a host write buffer is smallest, an operation of writing the write data corresponding to the selected QLC block to a pSLC block, and an operation of transmitting a completion response to the host and releasing a region in the host write buffer, the operations being executed in the memory system according to the embodiment.

FIG. 13 is a diagram illustrating an operation of selecting a QLC block in which the latest write command specifying the QLC block has been received at the oldest time point, an operation of writing data corresponding to the selected QLC block to a pSLC block, and an operation of transmitting a completion response to the host and releasing a region in the host write buffer, the operations being executed in the memory system according to the embodiment.

FIG. 14 is a diagram illustrating an operation of selecting, from among a plurality of QLC blocks in which data stored in the host write buffer is to be written thereto, a QLC block using a random number, an operation of writing data corresponding to the selected QLC block to a pSLC block, and an operation of transmitting a completion response to the host and releasing a region in the host write buffer, the operations being executed in the memory system according to the embodiment.

FIG. 15 is a sequence diagram illustrating a procedure of a write process with respect to a QLC block executed in the memory system according to the embodiment.

FIG. 16 is a flowchart illustrating a procedure of a write control process executed in the memory system according to the embodiment.

FIG. 17 is a sequence diagram illustrating a procedure of a process of managing a size of the host write buffer based on a notification from the host executed in the memory system according to the embodiment.

FIG. 18 is a diagram illustrating a pSLC block allocated to each of a plurality of QLC blocks opened as a write destination block in the memory system according to the embodiment.

FIG. 19 is a first diagram illustrating a write operation for a certain QLC block executed in the memory system according to the embodiment.

FIG. 20 is a second diagram illustrating the write operation for the certain QLC block executed in the memory system according to the embodiment.

FIG. 21 is a diagram illustrating a pSLC block that is reused by being allocated to another QLC block after allocation to a certain QLC block is released in the memory system according to the embodiment.

FIG. 22 is a diagram illustrating a relationship between a certain QLC block and a plurality of pSLC blocks allocated to the QLC block in the memory system according to the embodiment.

FIG. 23 is a diagram illustrating a foggy write operation executed using a temporary write buffer (TWB) in the memory system according to the embodiment.

FIG. 24 is a diagram illustrating a pSLC block allocated to each of a plurality of QLC blocks and a large write buffer (LWB) in the memory system according to the embodiment.

FIG. 25 is a diagram illustrating switching between two types of write operations executed in the memory system according to the embodiment.

FIG. 26 is a diagram illustrating a write operation executed using both the TWB and the LWB in the memory system according to the embodiment.

FIG. 27 is a diagram illustrating a write operation executed using the TWB in the memory system according to the embodiment.

FIG. 28 is a flowchart illustrating a procedure of an operation of allocating a pSLC block to a QLC block executed in the memory system according to the embodiment.

### DETAILED DESCRIPTION

Various embodiments will be described hereinafter with reference to the accompanying drawings.

In general, according to one embodiment, a memory system is connectable to a host including a memory. The memory system includes a nonvolatile memory and a controller. The nonvolatile memory includes a plurality of blocks, each of the plurality of blocks being a unit for a data erase operation. The controller is electrically connected to the nonvolatile memory and configured to manage a first set of blocks among the plurality of blocks and a second set of blocks among the plurality of blocks and control writing of data to a plurality of write destination blocks allocated from the first set of blocks. Each block in the first set of blocks has a first minimum write size. Each block in the second set of blocks has a second minimum write size smaller than the first minimum write size. The controller receives, from the host, a plurality of write commands each of which specifies any one of the plurality of write destination blocks. When a total size of write data associated with one or more received write commands which specify one write destination block among the plurality of write destination blocks reaches a first write size that enables completion of writing of data having the first minimum write size to the one write destination block, the controller executes a write operation for the one write destination block such that writing of write data having the first minimum write size to the one write destination block is completed. The write data having the first minimum write size is among pieces of write data stored in a write buffer of the memory in the host. The controller causes the host to release a region of the write buffer storing the write data written to the one write destination block, wherein the first write size is an integral multiple of the first minimum write size. When a plurality of pieces of write data, which are to be written to different write destination blocks, each having a total size smaller than the first write size are stored in the write buffer and a remaining capacity of the write buffer falls below a threshold, the controller selects a write destination block from among the different write destination blocks, writes, to a second block included in the second set of blocks, write data corresponding to the selected write destination block in units of the second minimum write size, and causes the host to release a region of the write buffer storing the write data written to the second block.

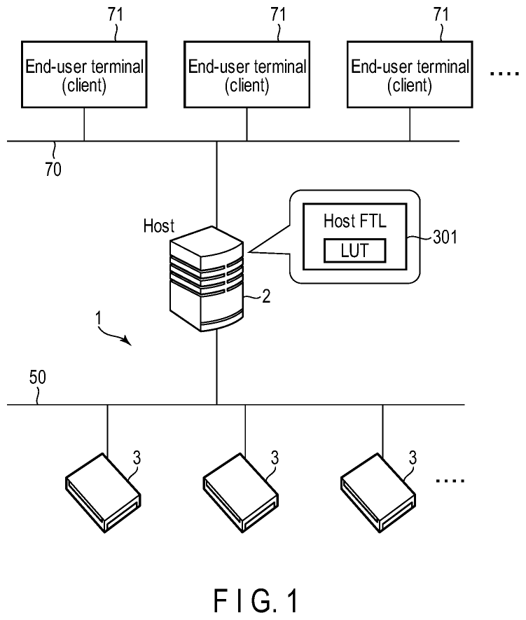

FIG. 1 is a block diagram illustrating an example of a configuration of an information processing system including a memory system according to an embodiment. The memory system according to the embodiment is a storage device including a nonvolatile memory.

An information processing system 1 includes a host (host device) 2 and a storage device 3. The host (host device) 2 is an information processing apparatus configured to access one or a plurality of storage devices 3. The information processing apparatus is, for example, a personal computer or a server computer.

Hereinafter, a case where the information processing apparatus such as a server computer is used as the host 2 will be mainly described.

A typical example of the server computer functioning as the host 2 includes a server computer (hereinafter, referred to as a server) in a data center.

In the case where the host 2 is realized by the server in the data center, the host 2 may be connected to the plurality of storage devices 3. Further, the host 2 may be connected to a plurality of end-user terminals (clients) 71 via a network 70. The host 2 can provide various services to these end-user terminals 71.

Examples of the services that can be provided by the host 2 include (1) Platform as a Service (PaaS) that provides a system operating platform to each client (each of the end-user terminals 71), and (2)

Infrastructure as a Service (IaaS) that provides an infrastructure, such as a virtual server, to each client (each of the end-user terminals 71).

A plurality of virtual machines may be executed on a physical server functioning as the host 2. Each virtual machine executed on the host 2 can function as a virtual server configured to provide various services to the client (end-user terminal 71) corresponding to the virtual machine. In each virtual machine, an operating system and a user application used by the end-user terminal 71 corresponding to the virtual machine are executed.

In the host (server) 2, a flash translation layer (host FTL) 301 is also executed. The host FTL 301 includes a lookup table (LUT). The LUT is an address translation table used to manage mapping between each data identifier and each physical address of the nonvolatile memory in the storage device 3. The host FTL 301 can know data placement on the nonvolatile memory in the storage device 3 by using the LUT.

The storage device 3 is a semiconductor storage device. The storage device 3 writes data to the nonvolatile memory. Then, the storage device 3 reads data from the nonvolatile memory.

The storage device 3 can execute low-level abstraction. The low-level abstraction is a function configured for abstraction of the nonvolatile memory. The low-level abstraction includes a function of assisting data placement and the like. The function of assisting data placement includes, for example, a function of allocating a physical address indicating a physical storage location in the nonvolatile memory where user data is to be written with respect to a write command transmitted from the host 2, and a function of notifying an upper layer (the host 2) of the allocated physical address.

The storage device 3 is connected to the host 2 through a cable or a network. Alternatively, the storage device 3 may be built in the host 2.

The storage device 3 executes communication with the host 2 to conform to a certain logical interface standard. The logical interface standard is, for example, Serial Attached SCSI (SAS), Serial ATA (SATA), or NVM express (trademark) (NVMe (trademark)) standard. When the NVMe standard is used as the logical interface standard, for example, PCI Express (trademark) (PCIe (trademark)) or Ethernet (trademark) is used as a physical interface 50 connecting the storage device 3 and the host 2.

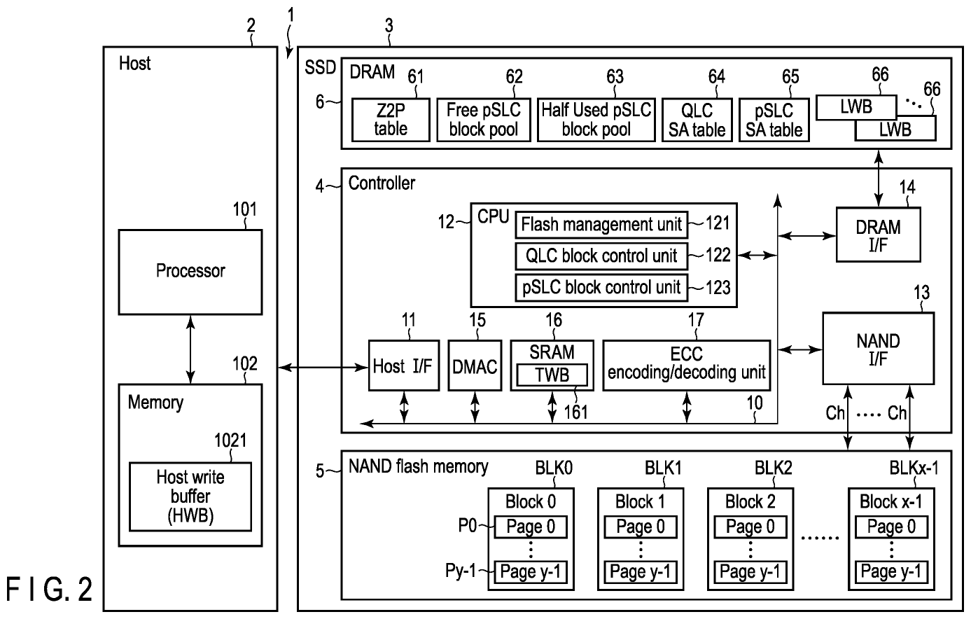

FIG. 2 is a block diagram illustrating an example of a configuration of a host and an example of a configuration of the memory system according to the embodiment. Hereinafter, it is assumed that the memory system according to the embodiment is realized as a solid state drive (SSD). Hereinafter, the memory system according to the embodiment will be described as an SSD 3. The information processing system 1 includes the host (host device) 2 and the SSD 3.

The host 2 is the information processing apparatus that accesses the SSD 3. The host 2 transmits a write request (write command), which is a request for writing data, to the SSD 3. In addition, the host 2 transmits a read request (read command), which is a request for reading data, to the SSD 3.

The host 2 includes a processor 101, a memory 102, and the like. The processor 101 is a central processing unit (CPU) configured to control an operation of each component in the host 2. The processor 101 executes software (host software) loaded from the SSD 3 into the memory 102. Note that the host 2 may include another storage device other than the SSD 3. In such a case, the host software may be loaded into the memory 102 from the other storage device. The host software includes an operating system, a file system, a device driver, an application program, and the like.

The memory 102 is a main memory provided in the host 2. The memory 102 is realized by, for example, a random access memory such as a dynamic random access memory (DRAM).

A part of a memory region of the memory 102 can be used as a host write buffer 1021. The host 2 temporarily stores data, which is to be written to the SSD 3, in the host write buffer 1021. That is, the host write buffer 1021 holds data associated with a write command transmitted to the SSD 3.

In addition, a part of the memory region of the memory 102 may be used to store one or more submission queue/completion queue pairs (SQ/CQ pairs) (not illustrated). Each SQ/CQ pair includes one or more submission queues (SQ) and one completion queue (CQ) associated with the one or more submission queues (SQ). The submission queue (SQ) is a queue used to issue a request (command) to the SSD 3. The completion queue (CQ) is a queue used to receive a response indicating command completion from the SSD 3. The host 2 transmits various commands to the SSD 3 via the one or more submission queues (SQ) included in each SQ/CQ pair.

The SSD 3 receives a write command and a read command transmitted from the host 2, and executes a data write operation and a data read operation for the nonvolatile memory based on the received write command and read command. As the nonvolatile memory, for example, a NAND flash memory is used.

The SSD 3 includes a controller 4 and a nonvolatile memory (for example, the NAND flash memory) 5. The SSD 3 may also include a random access memory, for example, a DRAM 6.

The controller 4 functions as a memory controller configured to control the NAND flash memory 5. The controller 4 can be realized by a circuit such as a system-on-a-chip (SoC). The controller 4 is electrically connected to the NAND flash memory 5 through a memory bus called a channel.

The NAND flash memory 5 is a nonvolatile semiconductor memory. The NAND flash memory 5 includes a memory cell array. The memory cell array includes a plurality of memory cells arranged in a matrix. The memory cell array in the NAND flash memory 5 includes a plurality of blocks BLK0 to BLKx-1. Each of the blocks BLK0 to BLKx-1 is a unit for a data erase operation for erasing data. The data erase operation is also simply referred to as an erase operation or erase. Each of the blocks BLK0 to BLKx-1 is also referred to as a physical block, a flash block, or a memory block.

Each of the blocks BLK0 to BLKx-1 includes a plurality of pages (here, pages P0 to Py-1). Each page includes a plurality of memory cells connected to the same word line. Each of the pages P0 to Py-1 is a unit for a data write operation and a data read operation.

Each of the blocks BLK0 to BLKx-1 is, for example, a quad-level cell block (QLC block). In an operation of writing data to each QLC block, 4-bit data is written per memory cell, whereby data of four pages is written in a plurality of memory cells connected to the same word line.

In addition, some of a plurality of QLC blocks may be used as pseudo single-level cell blocks (pSLC). In an operation of writing data to each pSLC block, 1-bit data is written per memory cell, whereby data of one page is written in a plurality of memory cells connected to the same word line.

The storage density per memory cell in the pSLC block is 1 bit (that is, one page per word line), and the storage density per memory cell in the QLC block is 4 bits (that is, four pages per word line). Thus, the minimum write size of the QLC block is four times the minimum write size of the pSLC block.

A read speed and a write speed of data with respect to the NAND flash memory 5 are lower as the storage density is higher, and are higher as the storage density is lower. Therefore, the time required for reading and writing data from and to the QLC block is longer than the time required for reading and writing data from and to the pSLC block.

The NAND flash memory 5 may include a plurality of NAND flash memory dies. Each NAND flash memory die may be a flash memory having a two-dimensional structure or a flash memory having a three-dimensional structure.

The DRAM 6 is a volatile semiconductor memory. The DRAM 6 is used, for example, to temporarily store data which is to be written in the NAND flash memory 5. In addition, a memory region of the DRAM 6 is used to store various types of management data to be used by the controller 4.

Next, a detailed configuration of the controller 4 will be described.

The controller 4 includes a host interface (I/F) 11, a CPU 12, a NAND interface (I/F) 13, a DRAM interface (I/F) 14, a direct memory access controller (DMAC) 15, a static RAM (SRAM) 16, and an error correction code (ECC) encoding/decoding unit 17.

The host interface 11, the CPU 12, the NAND interface 13, the DRAM interface 14, the DMAC 15, the SRAM 16, and the ECC encoding/decoding unit 17 are connected to each other through a bus 10.

The host interface 11 is a host interface circuit that executes communication with the host 2. The host interface 11 is, for example, a PCIe controller. Alternatively, when the SSD 3 is configured to incorporate a network interface controller, the host interface 11 may be realized as a part of the network interface controller. The host interface 11 receives various commands from the host 2. Examples of the various commands include a write command and a read command.

The CPU 12 is a processor. The CPU 12 controls the host interface 11, the NAND interface 13, the DRAM interface 14, the DMAC 15, the SRAM 16, and the ECC encoding/decoding unit 17. The CPU 12 loads a control program (firmware) from the NAND flash memory 5 or a ROM (not illustrated) into the DRAM 6 in response to the supply of power to the SSD 3.

The CPU 12 executes management of a block in the NAND flash memory 5. The management of a block in the NAND flash memory 5 is, for example, management of a defective block (bad block) included in the NAND flash memory 5 and wear leveling.

The NAND interface 13 is a memory interface circuit that controls a plurality of nonvolatile memory dies. The NAND interface 13 controls the NAND flash memory 5 under the control of the CPU 12. The NAND interface 13 is connected to a plurality of NAND flash memory dies through a plurality of channels (Ch), for example. The communication between the NAND interface 13 and the NAND flash memory 5 is executed to conform to, for example, a toggle NAND flash interface or open NAND flash interface (ONFI).

The DRAM interface 14 is a DRAM interface circuit that controls the DRAM. The DRAM interface 14 controls the DRAM 6 under the control of the CPU 12. A part of the memory region of the DRAM 6 is used to store a zone-to-physical address translation table (Z2P table) 61, a free pSLC block pool 62, a Half Used pSLC block pool 63, a QLC SA table 64, a pSLC SA table 65, and a large write buffer (LWB) 66.

The DMAC 15 is a circuit that executes direct memory access (DMA). The DMAC 15 executes data transfer between the memory 102 of the host 2 and the DRAM 6 (or the SRAM 16) under the control of the CPU 12. For example, when write data is to be transferred from the host write buffer 1021 of the host 2 to a temporary write buffer (TWB) 161 of the SRAM 16, the CPU 12 specifies a transfer source address indicating a position in the host write buffer 1021, a size of the write data to be transferred, and a transfer destination address indicating a position in the TWB 161 with respect to the DMAC 15. The TWB 161 is a memory region for temporarily storing write data associated with each write command received from the host 2. Here, it is assumed that a part of the memory region of the SRAM 16 is used as the TWB 161, but a part of the memory region of the DRAM 6 may be used as the TWB 161. In addition, the TWB 161 may have a memory region having a size equal to or larger than the minimum write size of the QLC block.

When data is to be written in the NAND flash memory 5, the ECC encoding/decoding unit 17 encodes the data to add an error correction code (ECC) as a redundant code to the data. When data is read from the NAND flash memory 5, the ECC encoding/decoding unit 17 executes error correction of the data using an ECC added to the read data.

Next, processes executed by the CPU 12 will be described. The CPU 12 can function as a flash management unit 121, a QLC block control unit 122, and a pSLC block control unit 123 by executing firmware. Note that some or all of the flash management unit 121, the QLC block control unit 122, and the pSLC block control unit 123 may be realized by dedicated hardware in the controller 4.

The flash management unit 121 controls an operation of writing write data to the NAND flash memory 5 based on a write command received from the host 2. The write command is a command (write request) for writing data (write data), which is to be written, to the NAND flash memory 5. As the write command received from the host 2, a write command used in a zoned namespace (ZNS) defined in the NVMe standard can be used.

In a case where the controller 4 supports the ZNS, the flash management unit 121 can operate the SSD 3 as a zoned device. In the zoned device, a plurality of zones to which a plurality of logical address ranges, obtained by dividing a logical address space for accessing the SSD 3, are respectively allocated are used as logical storage regions. One of a plurality of physical storage regions in the NAND flash memory 5 is allocated to each of the plurality of zones. As a result, the flash management unit 121 can treat each physical storage region in the NAND flash memory 5 as a zone.

The logical address space for accessing the SSD 3 is a continuous logical address used by the host 2 to access the SSD 3. As the logical address, a logical block address (LBA) is used.

Hereinafter, a case where the flash management unit 121 supports the ZNS and a write command used in the ZNS defined by the NVMe standard, that is, a write command specifying a zone is used as a write command for writing data to any zone will be mainly described.

The QLC block control unit 122 allocates a plurality of QLC blocks to a plurality of zones, respectively. The QLC block allocated to each of the plurality of zones may be one physical block (QLC physical block), or may be a block group including two or more QLC physical blocks. Each block group is also referred to as a super block (QLC super block). In this manner, the QLC block is allocated to each of the zones as a physical storage region. Therefore, the write command used in the ZNS can specify one write destination zone, that is, one write destination block (write destination QLC). Note that a write command specifying a physical address of a write destination block may be used instead of the write command specifying the zone. Both the write command specifying the zone and the write command specifying the physical address of the write destination block can be used as a write command specifying a write destination block.

The flash management unit 121 starts an operation of writing data to a QLC block allocated to a zone specified by a write command based on the write command received from the host 2. As the operation of writing data to the QLC block, the flash management unit 121 executes, for example, a multi-stage write operation. The multi-stage write operation includes at least a first-stage write operation and a second-stage write operation. The multi-stage write operation is, for example, a foggy-fine write operation.

The foggy-fine write operation is executed by a plurality of write operations (foggy write operation and fine write operation) for memory cells connected to the same word line. The first write operation (foggy write operation) is a write operation of roughly setting a threshold voltage of each memory cell, and the second write operation (fine write operation) is a write operation of adjusting the threshold voltage of each memory cell. The foggy-fine write operation is a write mode capable of reducing the influence of program disturb.

In the first write operation (foggy write operation), first, data of four pages is transferred to the NAND flash memory 5 in units of page size by the first data transfer operation. That is, when the data size (page size) per page is 16 KB, 64 KB of data is transferred to the NAND flash memory 5 in units of page size. Then, the first write operation (foggy write operation) for programming data of four pages into the memory cell array in the NAND flash memory 5 is performed.

In the second program operation (fine write operation), data of four pages is transferred again to the NAND flash memory 5 in units of page size in the second data transfer operation similarly to the foggy write operation. The data transferred to the NAND flash memory 5 in the second data transfer operation is the same as the data transferred in the first data transfer operation. Then, the second write operation (fine write operation) for programming the transferred data of four pages into the memory cell array in the NAND flash memory 5 is performed.

Even if a foggy write operation for a plurality of memory cells connected to a certain word line is finished, it is difficult to immediately execute a fine write operation for the plurality of memory cells connected to this word line. The fine write operation for the plurality of memory cells connected to the word line can be executed after a foggy write operation for memory cells connected to one or more subsequent word lines is finished. Thus, the time required for writing data in the QLC block takes longer. In addition, it is difficult to read data, written by a foggy write operation into a plurality of memory cells connected to a certain word line of the QLC block, until a foggy write operation for memory cells connected to one or more subsequent word lines is finished and a fine write operation for the plurality of memory cells connected to this word line is finished.

Thus, data that is to be written in the QLC block needs to be held in any storage region until a fine write operation of the data is finished.

In this manner, the flash management unit 121 writes data having the minimum write size of the QLC block (64 KB which is four times the page size) to a plurality of memory cells connected to each word line of the QLC block using the write mode (multi-stage write operation such as the foggy-fine write operation) in which reading of data written in one word line among the plurality of word lines included in the QLC block is enabled after writing of data into one or more word lines subsequent to the one word line.

Note that, in a case where the NAND flash memory 5 has a multi-plane configuration including two planes, write operations for two QLC physical blocks selected from the two planes are simultaneously executed. These two QLC physical blocks are treated as one QLC block (QLC super block) including the two QLC physical blocks. Therefore, the minimum write size of the QLC block is 128 KB.

On the other hand, in a write operation for a pSLC block, the flash management unit 121 writes data having the minimum write size (page size) of the pSLC block to a plurality of memory cells connected to each word line of the pSLC block using a write mode (SLC mode) in which reading of data written in one word line among a plurality of word lines included in the pSLC block is enabled only by writing of data to the one word line. In the SLC mode, data of one page is transferred to the NAND flash memory 5 only once. Then, data of one page is written to a plurality of memory cells connected to one word line such that 1 bit is written per memory cell.

Hereinafter, the minimum write size of the QLC block is also referred to as a first minimum write size, and the minimum write size of the pSLC block is also referred to as a second minimum write size.

The flash management unit 121 selectively executes writing to the QLC block and writing to the pSLC block in order to reduce the number of blocks that need to be allocated as the pSLC blocks.

That is, the flash management unit 121 receives a plurality of write commands, each of which specifies any one of a plurality of write destination blocks (a plurality of write destination QLC blocks), from the host 2. The flash management unit 121 determines whether a total size of write data associated with one or more received write commands specifying any one write destination QLC block among the plurality of write destination QLC blocks has reached a first write size at which writing of data having the first minimum write size (for example, 128 KB) can be completed. A total size of the write data associated with one or more received write commands specifying a certain write destination QLC block indicates a sum of data sizes specified by the one or more received write commands.

For example, in a case where the multi-stage write operation is performed across five word lines included in the write destination QLC block, the first write size is 640 KB (=128 KB×5).

When write data of 640 KB, which is to be written in a certain write destination QLC block, is stored in the host write buffer 1021, a foggy write operation for a plurality of memory cells, connected to each of certain five word lines among a plurality of word lines included in the write destination QLC block, and a fine write operation for a plurality of memory cells, connected to the first word line among the five word lines, can be executed. As a result, it is possible to complete writing of data of 128 KB to a plurality of memory cells connected to the first word line. Therefore, the data of 128 KB can be read from the NAND flash memory 5.

For example, in a case where the multi-stage write operation is performed across six word lines included in the write destination QLC block, the first write size is 768 KB (=128 KB×6).

When write data of 768 KB, which is to be written in a certain write destination QLC block, is stored in the host write buffer 1021, a foggy write operation for a plurality of memory cells, connected to each of certain six word lines among a plurality of word lines included in the write destination QLC block, and a fine write operation for a plurality of memory cells, connected to the first word line among the six word lines, can be executed. As a result, it is possible to complete writing of data of 128 KB to a plurality of memory cells connected to the first word line. Therefore, the data of 128 KB can be read from the NAND flash memory 5.

In this manner, the first write size has a size that is an integral multiple of the first minimum write size. Note that, in a case where a write destination block is a triple-level cell block (TLC block) and data of three pages is written in each word line of the TLC block in a full sequence mode, the first minimum write size is 48 KB. When the NAND flash memory 5 has a multi-plane configuration including two planes, the minimum write size of the TLC block is 96 KB. When data is written in the TLC block in the full sequence mode, writing of the data of three pages to the TLC block is completed by writing the data of three pages to the TLC block. Therefore, the first write size at which writing of data having the first minimum write size (for example, 96 KB) can be completed is equal to the first minimum write size (for example, 96 KB).

Hereinafter, a case where a QLC block is used as a write destination block will be mainly described.

When a total size of write data associated with one or more received write commands specifying a certain write destination QLC block reaches the first write size (for example, 640 KB) at which writing of data having the first minimum write size (for example, 128 KB) can be completed, the flash management unit 121 executes a write operation for the write destination QLC block such that writing of the write data having the first minimum write size to the write destination QLC block among pieces of write data stored in the host write buffer 1021 is completed. That is, the flash management unit 121 directly writes the write data stored in the host write buffer 1021 to the write destination QLC block without using a pSLC block. As a result, it is possible to complete the writing of the write data of 128 KB. Then, the flash management unit 121 transmits one or more completion responses to one or more write commands corresponding to the write data, which has been written, to the host 2, thereby causing the host 2 to release a region of the host write buffer 1021 in which the write data, writing of which has been completed, is stored.

In the host write buffer 1021, write data to be written to a plurality of write destination QLC blocks is stored. When a plurality of pieces of write data to be written to different write destination blocks each having a total size smaller than the first write size are stored in the host write buffer 1021 so that the remaining capacity of the host write buffer 1021 falls below a threshold, the flash management unit 121 selects one write destination block from among the different write destination blocks. Then, the flash management unit 121 writes write data corresponding to the selected one write destination block to a pSLC block in units of the second minimum write size. As a result, writing of the write data to the pSLC block is completed, and thus, the write data can be read from the NAND flash memory 5. The flash management unit 121 transmits one or more completion responses to one or more write commands corresponding to the write data written in the pSLC block to the host 2, thereby causing the host 2 to release a region of the host write buffer 1021 in which the write data written in the pSLC block is stored. As a result, the remaining capacity of the host write buffer 1021 can be increased.

As the threshold, the minimum write size (for example, 128 KB) of the write destination QLC block can be used. As a result, a region in which new write data having the minimum write size of the write destination QLC block can be stored can be secured in the host write buffer 1021.

In a case where writing to a specific write destination QLC block is concentrated by the host 2, a total size of write data associated with one or more received write commands specifying the specific write destination QLC block may reach the first write size (for example, 640 KB) before the entire host write buffer 1021 is filled with write data. In this case, the flash management unit 121 can directly write the write data to be written to the specific write destination QLC block without passing through a pSLC block. Therefore, the number of required pSLC blocks can be reduced as compared with a case where all pieces of data are written to individual write destination QLC blocks via a pSLC block group.

For example, in a case where the capacity of the host write buffer 1021 is 1 MB and the host write buffer 1021 is shared by eight zones (eight write destination QLC blocks), write data to be written to one write destination QLC block having a larger amount of writing by the host 2 among the eight write destination QLC blocks can be directly written in the one write destination QLC block without passing through the pSLC block. In this case, when write data of 640 KB to be written in this one write destination QLC block is accumulated in the host write buffer 1021, writing of write data of 128 KB to a certain word line of this one write destination QLC block is completed. A region in the host write buffer 1021 in which the write data of 128 KB, writing of which has been completed, is stored is released. A size of the write data corresponding to this one write destination QLC block stored in the host write buffer 1021 is 512 KB. The released region of 128 KB can be used to store new write data of 128 KB. When the new write data of 128 KB with respect to this one write destination QLC block is accumulated in the host write buffer 1021, writing of the write data of 128 KB with respect to another word line of this one write destination QLC block is completed. In this manner, the region of 640 KB in the host write buffer 1021 of 1 MB is used to store the write data corresponding to the specific write destination QLC block having the larger amount of writing by the host 2. Then, the remaining region of 384 KB in the host write buffer 1021 of 1 MB is used to store write data corresponding to the other seven write destination QLC blocks.

For example, in a case where the capacity of the host write buffer 1021 is 3 MB and the host write buffer 1021 is shared by eight zones (eight write destination QLC blocks), write data to be written in four write destination QLC blocks each having a larger amount of writing by the host 2 among the eight write destination QLC blocks can be directly written to the one write destination QLC block without passing through the pSLC block.

Next, allocation of a pSLC block will be described. The pSLC block control unit 123 allocates pSLC blocks respectively to write destination QLC blocks which have been determined to write corresponding write data to the pSLC blocks in order to prevent pieces of data to be written to different QLC blocks from being mixed in one pSLC block. A pSLC block allocated to a certain write destination QLC block is used as a nonvolatile storage region that temporarily holds only data to be written in this write destination QLC block. That is, only data to be written in a certain write destination QLC block is written in a pSLC block allocated to this write destination QLC block. Data to be written in another write destination QLC block is written in the pSLC block allocated to this another write destination QLC block.

Therefore, one pSLC block is used to hold only write-incompleted data of one write destination QLC block, and does not hold pieces of write-incompleted data of a plurality of write destination QLC blocks at the same time. That is, it is possible to prevent a plurality of types of data to be written in different write destination QLC blocks from being mixed in one pSLC block. Therefore, execution of a garbage collection operation for the pSLC block becomes unnecessary.

In addition, in a state where an unwritten region remains in a pSLC block allocated to a certain write destination QLC block, the pSLC block control unit 123 deallocates this pSLC block from this write destination QLC block when the write destination QLC block is filled with readable data. Here, the readable data is data that has been written in a write destination QLC block. Specifically, when writing to a write destination QLC block is executed using a multi-stage write operation, the readable data is data for which the multi-stage write operation is completed. For example, when a fine write operation of certain data is completed, this data becomes the readable data. When the write destination QLC block is filled with the readable data, all pieces of data that have been already written in the pSLC block become write-completed data, writing of which to the write destination QLC block has been completed. The write-completed data stored in the pSLC block can be read from the write destination QLC block. Therefore, the write-completed data, writing of which to the write destination QLC block has been completed, is no longer required to be held in the pSLC block.

In this case, the pSLC block control unit 123 allocates this deallocated pSLC block to another write destination QLC block. Then, only data to be written in the other write destination QLC block is written in an unwritten region of this pSLC block. In this manner, the pSLC block control unit 123 reuses the deallocated pSLC block as a nonvolatile storage region that temporarily holds only the data to be written to the another write destination QLC block, and effectively uses the unwritten region of the pSLC block.

Data to be subjected to the garbage collection operation is only write-incompleted data writing of which to a write destination QLC block has not been completed. Therefore, even if data to be written in another write destination QLC block is written in a remaining storage region of a pSLC block allocated to a certain write destination QLC block, write-uncompleted data existing in this pSLC block is only write-incompleted data for the another write destination QLC block. That is, write-uncompleted data corresponding to a different write destination QLC block is not mixed in the pSLC block. Therefore, the garbage collection operation for the reused pSLC block is also unnecessary.

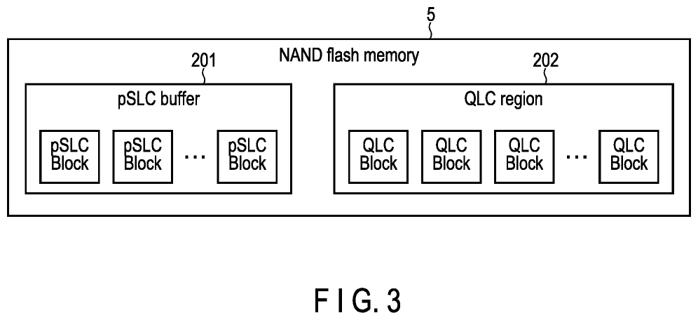

Next, a storage region in the NAND flash memory 5 will be described. As illustrated in FIG. 3, the storage region in the NAND flash memory 5 is roughly divided into a pSLC buffer 201 and a QLC region 202.

The QLC region 202 includes a plurality of QLC blocks. The pSLC buffer 201 includes a plurality of pSLC blocks. In other words, a plurality of blocks included in the NAND flash memory 5 can include a QLC block group and a pSLC block group. The QLC block group is a set of QLC blocks. The pSLC block group is a set of pSLC blocks. The QLC block control unit 122 may use each of the plurality of QLC blocks included in the QLC region 202 only as a QLC block, and the pSLC block control unit 123 may use each of the plurality of pSLC blocks included in the pSLC buffer 201 only as a pSLC block.

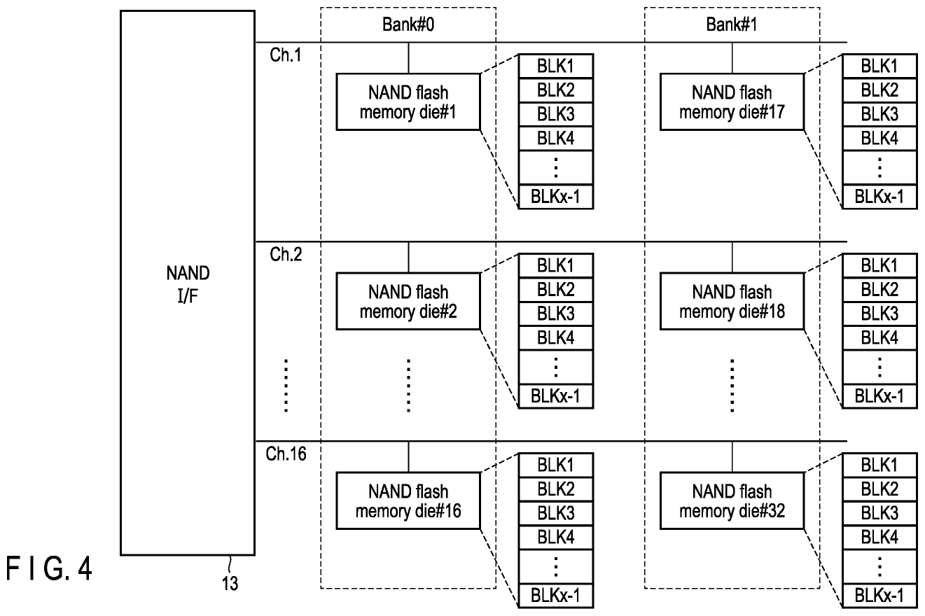

Next, a relationship between a plurality of channels and a plurality of NAND flash memory dies will be described. FIG. 4 is a block diagram illustrating an example of the relationship between the plurality of channels and the plurality of NAND flash memory dies used in the memory system according to the embodiment.

The NAND flash memory 5 includes the plurality of NAND flash memory dies (or also referred to as NAND flash memory chips). The individual NAND flash memory dies are independently operable. Thus, the NAND flash memory dies are treated as units that are operable in parallel.

FIG. 4 illustrates a case where sixteen channels Ch. 1 to Ch. 16 are connected to the NAND interface 13, and two NAND flash memory dies are connected to each of the sixteen channels Ch. 1 to Ch. 16. In this case, the sixteen NAND flash memory dies #1 to #16 connected to the channels Ch. 1 to Ch. 16 may be configured as a bank #0, and the remaining sixteen NAND flash memory dies #17 to #32 connected to the channels Ch. 1 to Ch. 16 may be configured as a bank #1. The bank is a unit for operating a plurality of memory modules in parallel by bank interleaving. In the configuration example of FIG. 4, 32 NAND flash memory dies at most can be operated in parallel by the sixteen channels and bank interleaving using the two banks.

An erase operation may be executed in a unit of one block (physical block) or in a unit of block group (super block) including a set of a plurality of physical blocks that can operate in parallel.

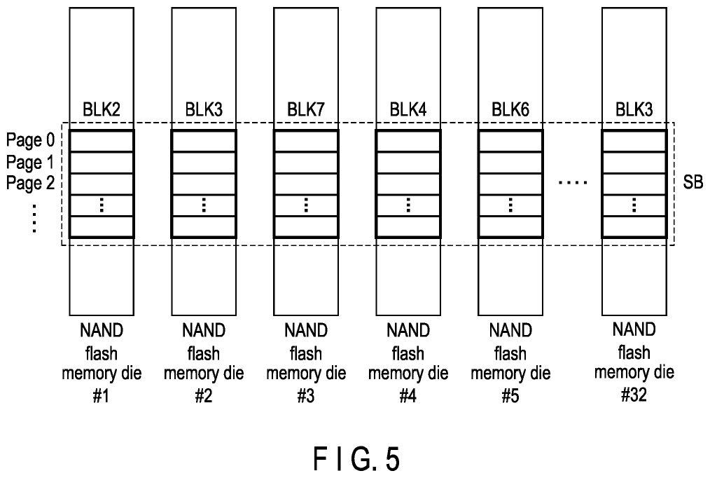

Next, an example of a configuration of a super block will be described. FIG. 5 is a diagram illustrating an example of a configuration of a certain block group (super block) used in the memory system according to the embodiment.

One block group, that is, one super block including a set of a plurality of physical blocks is not limited thereto, but may include a total of 32 physical blocks selected one by one from the NAND flash memory dies #1 to #32. Note that each of the NAND flash memory dies #1 to #32 may have a multi-plane configuration. For example, in a case where each of the NAND flash memory dies #1 to #32 has a multi-plane configuration including two planes, one super block may include a total of 64 physical blocks selected one by one from 64 planes corresponding to the NAND flash memory dies #1 to #32.

FIG. 5 illustrates one super block (SB) including 32 physical blocks (here, the physical block BLK2 in the NAND flash memory die #1, the physical block BLK3 in the NAND flash memory die #2, the physical block BLK7 in the NAND flash memory die #3, the physical block BLK4 in the NAND flash memory die #4, the physical blocks BLK6 in the NAND flash memory die #5, and . . . , the physical block BLK3 in the NAND flash memory die #32).

Each QLC block in QLC region 202 described with reference to FIG. 3 may be realized by one super block (QLC super block) or one physical block (QLC physical block). Note that a configuration in which one super block includes only one physical block may be adopted. In such a case, one super block is equivalent to one physical block.

Each pSLC block included in the pSLC buffer 201 may also be configured by one physical block or a super block including a set of a plurality of physical blocks.

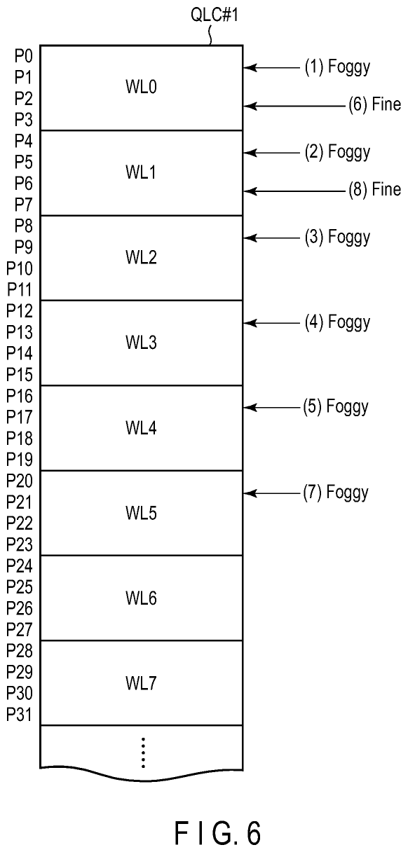

Next, a foggy-fine write operation for a QLC block executed by the flash management unit 121 will be described. FIG. 6 is a diagram for describing an operation of writing data in a mode of writing 4 bits per memory cell in a QLC block.

Here, a foggy-fine write operation in a case of reciprocating among five word lines will be illustrated. The foggy-fine write operation for the QLC block (QLC #1) is executed as follows.

(1) First, write data of four pages (P0 to P3) is transferred to the NAND flash memory 5 in units of pages, and a foggy write operation for writing the write data of these four pages (P0 to P3) is executed in a plurality of memory cells connected to a word line WL0 in QLC #1.

(2) Next, write data of next four pages (P4 to P7) is transferred to the NAND flash memory 5 in units of pages, and a foggy write operation for writing the write data of these four pages (P4 to P7) is executed in a plurality of memory cells connected to a word line WL1 in QLC #1.

(3) Next, write data of next four pages (P8 to P11) is transferred to the NAND flash memory 5 in units of pages, and a foggy write operation for writing the write data of these four pages (P8 to P11) is executed in a plurality of memory cells connected to a word line WL2 in QLC #1.

(4) Next, write data of next four pages (P12 to P15) is transferred to the NAND flash memory 5 in units of pages, and a foggy write operation for writing the write data of these four pages (P12 to P15) is executed in a plurality of memory cells connected to a word line WL3 in QLC #1.

(5) Next, write data of next four pages (P16 to P19) is transferred to the NAND flash memory 5 in units of pages, and a foggy write operation for writing the write data of these four pages (P16 to P19) is executed in a plurality of memory cells connected to a word line WL4 in QLC #1.

(6) When the foggy write operation for the plurality of memory cells connected to the word line WL4 is finished, a word line as a write target returns to the word line WL0, and a fine write operation for the plurality of memory cells connected to the word line WL0 can be executed. Then, the write data of four pages (P0 to P3), which is the same as the write data of four pages (P0 to P3) used in the foggy write operation for the word line WL0, is transferred again to the NAND flash memory 5 in units of pages, and the fine write operation for writing the write data for these four pages (P0 to P3) is executed in the plurality of memory cells connected to the word line WL0 in QLC #1. As a result, the foggy-fine write operation for the pages P0 to P3 is completed. As a result, data corresponding to the pages P0 to P3 can be correctly read from QLC #1.

(7) Next, write data of next four pages (P20 to P23) is transferred to the NAND flash memory 5 in units of pages, and a foggy write operation for writing the write data of these four pages (P20 to P23) is executed in a plurality of memory cells connected to a word line WL5 in QLC #1.

(8) When the foggy write operation for the plurality of memory cells connected to the word line WL5 is finished, a word line as a write target returns to the word line WL1, and a fine write operation for the plurality of memory cells connected to the word line WL1 can be executed. Then, the write data of four pages (P4 to P7), which is the same as the write data of four pages (P4 to P7) used in the foggy write operation for the word line WL1, is transferred again to the NAND flash memory 5 in units of pages, and the fine write operation for writing the write data for these four pages (P4 to P7) is executed in the plurality of memory cells connected to the word line WL1 in QLC #1. As a result, the foggy-fine write operation for the pages P4 to P7 is completed. As a result, data corresponding to the pages P4 to P7 can be correctly read from QLC #1.

Note that the case where data of four pages is transferred to the NAND flash memory 5 in each of the foggy write operation and the fine write operation has been described herein. However, in a case where QLC #1 includes two QLC physical blocks respectively selected from two planes included in the NAND flash memory 5, write operations for the two QLC physical blocks are simultaneously executed. Thus, data of eight pages is transferred to the NAND flash memory 5 in each of the foggy write operation and the fine write operation.

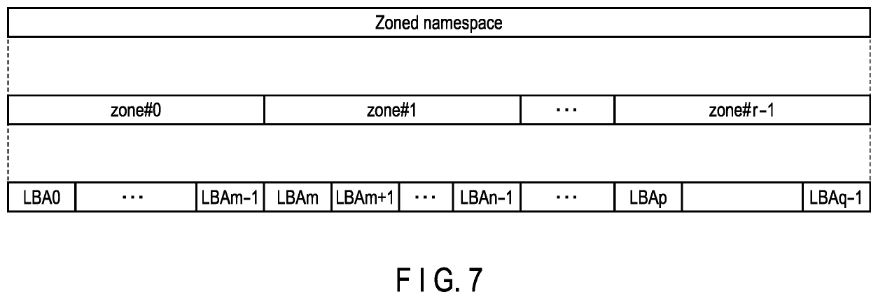

Next, a configuration of a plurality of zones will be described. FIG. 7 is a diagram illustrating an example of a configuration of the zoned namespace defined by the NVMe standard.

A logical block address range of each zoned namespace starts from an LBA 0. For example, the logical block address range of the zoned namespace of FIG. 7 includes q consecutive LBAs from the LBA 0 to an LBA q−1. This zoned namespace is divided into r zones from a zone #0 to a zone #r−1. These r zones include consecutive non-overlapping logical block addresses.

More specifically, the zone #0, the zone #1, . . . , and the zone #r−1 are allocated to the zoned namespace. The LBA 0 indicates the minimum LBA of the zone #0. The LBA q−1 indicates the maximum LBA of the zone #r−1. The zone #0 includes the LBA 0 and an LBA m−1. The LBA 0 indicates the minimum LBA of the zone #0. The LBA m−1 indicates the maximum LBA of the zone #0. The zone #1 includes an LBA m, an LBA m+1, . . . , and LBA n−2, and an LBA n−1. The LBA m indicates the minimum LBA in the zone #1. The LBA n−1 indicates the maximum LBA of the zone #1. The zone #r−1 includes an LBA p, . . . , and the LBA q−1. The LBA p indicates the minimum LBA in the zone #r−1. The LBA q−1 indicates the maximum LBA of the zone #r−1.

The controller 4 allocates one of a plurality of QLC blocks to each of the plurality of zones as a physical storage region. Further, the controller 4 manages mapping between each of the plurality of QLC blocks and each of the plurality of zones using the Z2P table 61.

For example, when a write command for writing data to a certain zone is received from the host 2, the controller 4 determines a QLC block allocated to this zone as a write destination block, and writes the data associated with the received write command to this write destination block. In addition, when a write command for writing data to another zone is received from the host 2, the controller 4 determines a QLC block allocated to the another zone as a write destination block, and writes the data associated with the received write command to this write destination block.

The write command includes, for example, a logical address (start LBA) indicating a first sector in which write data is to be written, a data size of the write data, and a data pointer (buffer address) indicating a position in the host write buffer 1021 in which the write data is stored.

For example, an upper bit portion of the logical address (start LBA) included in the write command is used as an identifier specifying a zone in which the write data associated with the write command is to be written, that is, a zone start logical block address (ZSLBA) of the zone. Since the QLC blocks are allocated to the zones, respectively, the ZSLBA is also used as an identifier specifying a QLC block to which the data is to be written. In addition, a lower bit portion of the logical address (start LBA) included in the write command is used as a write destination LBA (offset) in the zone in which the write data is to be written.

Therefore, the logical address specified by the write command indicates both of one zone among the plurality of zones and the offset from the head of the zone to a write destination position in the zone. Note that a zone-append command specifying only a ZSLBA may be used as a write command. In this case, a write destination LBA (offset) in a zone is determined by the controller 4 such that write operations in this zone are sequentially executed.

A data size of write data may be specified by, for example, the number of sectors (logical blocks). One sector corresponds to the minimum data size of write data that can be specified by the host 2. That is, the data size of the write data is represented by a multiple of the sector.

A value of the next writable LBA in each zone is managed by a write pointer corresponding to each zone.

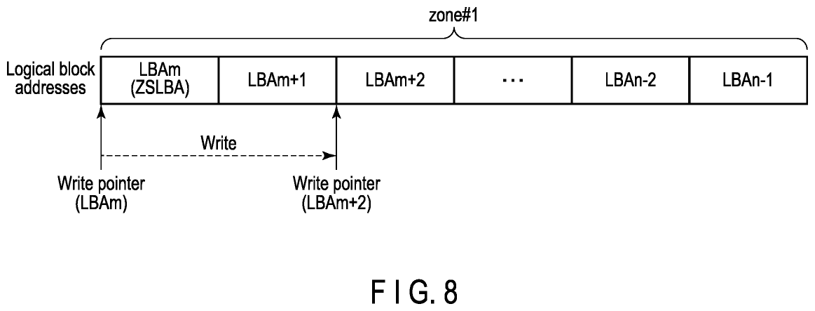

Next, an operation of updating the write pointer will be described. FIG. 8 is a diagram illustrating the operation of updating the write pointer executed in the memory system according to the embodiment.

The controller 4 manages a plurality of write pointers corresponding to a plurality of zones. Each write pointer indicates the next writable LBA in a zone corresponding to the write pointer. When pieces of data are sequentially written in a certain zone, the controller 4 increases a value of the write pointer corresponding to this zone by the number of logical blocks in which the data has been written.

Here, the operation of updating the write pointer will be described using the zone #1 as an example. The zone #1 includes the logical block address range from the LBA m to the LBA n−1. The LBA m is the minimum logical block address of the zone #1, that is, the zone start logical block address (ZSLBA) of the zone #1.

When the zone #1 is in an empty state including no valid data, a write pointer corresponding to the zone #1 indicates the LBA m that is the zone start logical block address of the zone #1. When a command for opening the zone #1 is received from the host 2, the controller 4 changes the state of the zone #1 to an open state in which data can be written. In this case, the controller 4 allocates one of empty QLC blocks (free QLC blocks) including no valid data as a physical storage region in the open state associated with the zone #1, and executes the erase operation for the one QLC block. As a result, the one QLC block is opened as a write destination QLC block. As a result, writing to the zone #1 becomes possible.

When a write destination position (start LBA) specified by a write command specifying the zone #1 is equal to the write pointer (here, LBA m) of the zone #1, the controller 4 writes data to the LBA range starting from the specified start LBA, for example, the LBA m and the LBA m+1.

The controller 4 updates the write pointer of the zone #1 such that a value of the write pointer of the zone #1 is increased by the number of logical blocks in which data has been written. For example, when the data has been written in the LBA m and the LBA m+1, the controller 4 updates the value of the write pointer to an LBA m+2. The LBA m+2 indicates the minimum LBA among unwritten LBAs in the zone #1, that is, the next writable LBA in the zone #1.

When data is written again to a certain LBA range in the zone #1 in which data has already been written, it is necessary to reset the zone #1, return the value of the write pointer to the LBA m, and open the zone #1 again.

Commands received by the controller 4 from the host 2 include a read command, an open zone command, a close zone command, a reset zone command, and the like in addition to the write command.

The read command is a command (read request) for reading data from the NAND flash memory 5. The read command includes a logical address (start LBA) indicating a first sector from which data (read target data) is to be read, a data size of the read target data, and a data pointer (buffer address) indicating a position in a read buffer of the host 2 to which the read target data is to be transferred. The read buffer of the host 2 is a memory region provided in the memory 102 of the host 2.

An upper bit portion of the logical address included in the read command is used as an identifier specifying a zone in which the read target data is stored. In addition, a lower bit portion of the logical address included in the read command specifies an offset in the zone in which the read target data is stored.

The open zone command is a command (open request) for shifting one of a plurality of zones each of which is in the empty state to the open state available for writing of data. That is, the open zone command is used to shift a specific block group in the empty state including no valid data to the open state available for writing of data.

The open zone command includes a logical address specifying a zone to be shifted to the open state. For example, an upper bit portion of the logical address specified by the open zone command is used as an identifier specifying the zone to be shifted to the open state.

The close zone command is a command (close request) for shifting one of zones in the open state to a closed state in which writing is interrupted. The close zone command includes a logical address specifying a zone to be shifted to the closed state. For example, an upper bit portion of the logical address specified by the close zone command is used as an identifier specifying the zone to be shifted to the closed state.

The reset zone command is a command (reset request) for resetting a zone in which rewriting is to be executed to be caused transitioning to the empty state. For example, the reset zone command is used to cause a zone in a full state, which is filled with data, transitioning to the empty state including no valid data. The valid data means data associated with the logical address. The reset zone command includes a logical address specifying a zone to be caused transitioning to the empty state. For example, an upper bit portion of the logical address specified by the reset zone command is used as an identifier specifying the zone to be caused transitioning to the empty state. A value of a write pointer corresponding to a zone that has been caused transitioning to the empty state by the reset zone command is set to a value indicating a ZSLBA of this zone.

For example, when the zone #1 is reset, the controller 4 can treat a QLC block, which has been allocated as a physical storage region for the zone #1, as a free QLC block including no valid data. Therefore, the QLC block can be reused for writing of data only by performing the erase operation for the QLC block.

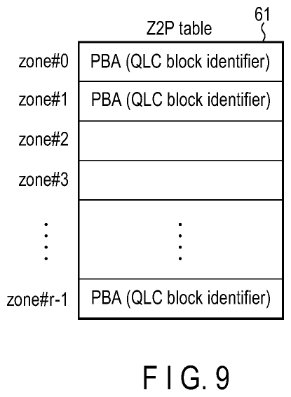

FIG. 9 is a diagram illustrating an example of a configuration of the Z2P table 61 which is a management table for managing a correspondence relationship between each of a plurality of zones and each of a plurality of QLC blocks used in the memory system according to the embodiment.

The Z2P table 61 has a plurality of entries corresponding to a plurality of zones included in any zoned namespace. In FIG. 9, the Z2P table 61 has r entries for managing r zones.

In each of the plurality of entries, an identifier (QLC block identifier) indicating a QLC block allocated to a zone corresponding to the entry is stored as a physical address PBA of a physical storage region corresponding to the zone. In FIG. 9, a QLC block identifier indicating a QLC block allocated to the zone #0 is stored in an entry corresponding to the zone #0. In an entry corresponding to the zone #1, a QLC block identifier indicating a QLC block allocated to the zone #1 is stored. Further, a QLC block identifier indicating a QLC block allocated to the zone #r−1 is stored in the entry corresponding to the zone #r−1.

Although FIG. 9 illustrates the Z2P table 61 corresponding to the certain zoned namespace, the Z2P table 61 may include entries corresponding to a plurality of zones included in a plurality of zoned namespaces.

In this manner, write data is written in the QLC block allocated to the zone specified by the write command received from the host 2 in the SSD 3 conforming to the zoned namespace. In the write operation for the QLC block, however, a write operation requiring a plurality of program operations, such as the foggy-fine write operation, may be executed. At this time, it is necessary to hold data in a storage region other than the QLC block between the first write operation and the last write operation.

In addition, in a case where the SSD 3 is used as a storage device of a server computer, for example, there is a case where a plurality of zones corresponding to a plurality of applications (or a plurality of clients) are simultaneously used such that a plurality of types of data are written in different zones. In this case, the time from the start of writing to a zone to this zone becoming the full state in which the entire zone is filled with data sometimes differs for each zone.

In such a case, if pieces of data to be written in a plurality of zones are mixed in one pSLC block, necessary data (valid data) and unnecessary data (invalid data) are mixed in the one pSLC block due to a difference in the timing of write completion between the respective zones. Data (write-completed data) that has been written to a certain QLC block can be read from the QLC block. Therefore, the write-completed data stored in a pSLC block is unnecessary data. The data (write-incompleted data), which has not been written in a certain QLC block, cannot be read from the QLC block. Therefore, the write-incompleted data stored in a pSLC block is necessary data.

When the number of free pSLC blocks available for writing of data decreases, it is necessary to execute a garbage collection operation of copying only valid data (write-incompleted data) from a pSLC block in which necessary data and unnecessary data are mixed to another pSLC block.

However, the execution of the garbage collection operation is likely to cause deterioration in write amplification due to occurrence of a write operation for the NAND flash memory 5 regardless of an instruction from the host 2, such as a write command, and an increase in latency for a command issued from the host 2 due to use of the NAND flash memory 5.

Therefore, the controller 4 respectively allocates a plurality of pSLC blocks to a plurality of QLC blocks opened as write destination blocks in the present embodiment. Then, the controller 4 writes only data to be written to the corresponding QLC block to each of the pSLC blocks. Then, the pSLC block holds the written data as write-incompleted data until a fine write operation related to the data written in the pSLC block is executed. The data written in the pSLC block gradually transitions from the write-incompleted data to the write-completed data as writing to the corresponding QLC block proceeds. When the entire pSLC block is filled with pieces of data and all pieces of the data become the write-completed data, the pSLC block becomes a free block including no valid data.

In this manner, the controller 4 can efficiently write data to the plurality of QLC blocks without increasing the write amplification by allocating the pSLC block to each QLC block opened as the write destination block.

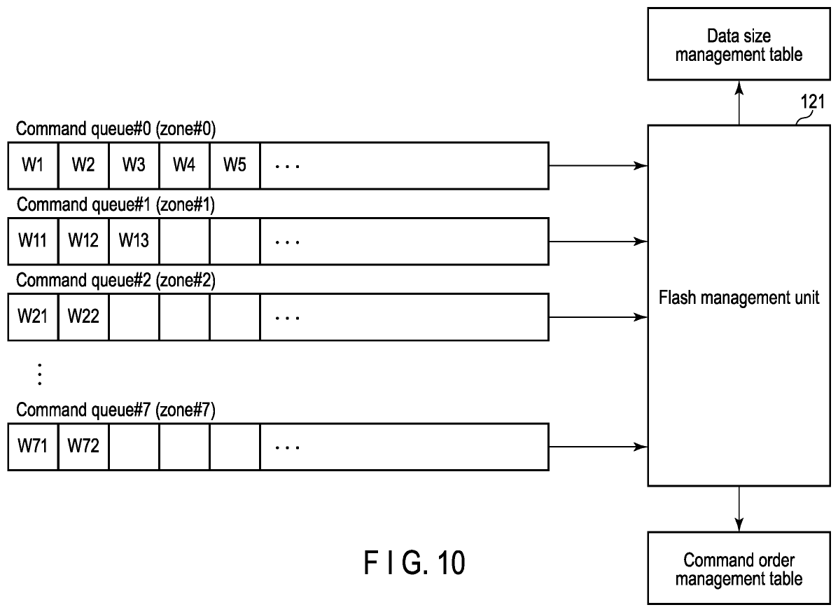

Next, management, executed in the memory system, of a plurality of write commands received from the host will be described. FIG. 10 is a diagram illustrating an operation of managing a plurality of write commands received from the host, the operation being executed in the memory system according to the embodiment. The flash management unit 121 controls writing of data to the NAND flash memory 5 by acquiring a write command stored in a command queue. Here, a case where the memory system 3 manages eight zones (zone #0, zone #1, zone #2, zone #3, zone #4, zone #5, zone #6, and zone #7) will be described.

When a write command is received from the host 2, the host interface 11 determines a command queue in which the write command is to be stored according to a zone identifier specified by the write command. Then, the host interface 11 stores the write command in the determined command queue. For example, the host interface 11 stores write commands W1, W2, W3, W4, and W5 specifying the zone #0 in a command queue #0, stores write commands W11, W12, and W13 specifying the zone #1 in a command queue #1, stores write commands W21 and W22 specifying the zone #2 in a command queue #2, and stores write commands W71 and W72 specifying the zone #7 in a command queue #7.

In response to a new write command is stored in a command queue, the flash management unit 121 may record that the write command specifying a zone corresponding to the command queue has been issued, thereby recording the order of the issued write commands. In addition, the flash management unit 121 may record a zone in which a new write command has been issued, instead of recording the order of write commands. In either case, the flash management unit 121 can manage the order of zones in which the latest write command has been issued. For example, when a write command specifying the zone #0, a write command specifying the zone #1, and a write command designating the zone #7 are received from the host 2 in this order, the flash management unit 121 manages the order indicating “zone #0→zone #1→zone #7” as the order of zones in which the latest write command has been issued.

The flash management unit 121 acquires a data size of write data to be written to each zone by acquiring a write command from a command queue. For example, the flash management unit 121 acquires a data size of write data to be written to the zone #0 by acquiring information of the write commands W1, W2, W3, W4, and W5 stored in the command queue #0. That is, the data size of the write data to be written in the zone #0 stored in the HWB 1021 of the host 2 can be acquired. The flash management unit 121 may manage the size of the write data to be written to each zone using a data size management table.

The flash management unit 121 uses each of data sizes of pieces of write data to be written to the respective zones and a sum thereof to determine which write command specifying any zone is to be processed.

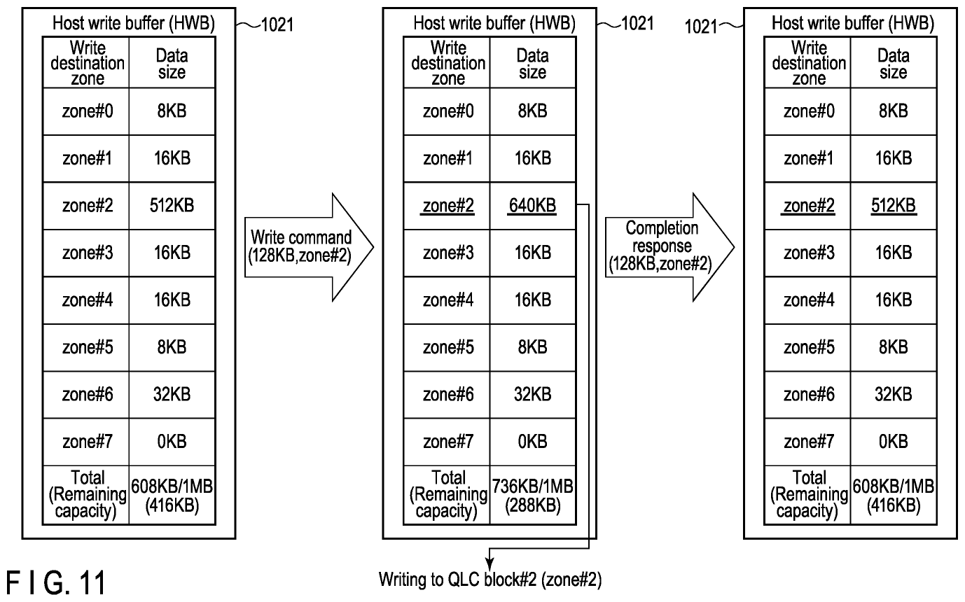

Next, an operation of determining a zone in which write data is to be directly written in a QLC block without passing through a pSLC block will be described. FIG. 11 is a diagram illustrating a write operation for a QLC block and an operation of transmitting a completion response to the host and releasing a region in the host write buffer, the operations being executed in the memory system according to the embodiment.

Here, a case where the memory system 3 manages eight zones (zone #0, zone #1, zone #2, zone #3, zone #4, zone #5, zone #6, and zone #7) will be described.

For example, a case where the capacity of the HWB 1021 is 1 MB (1024 KB) is assumed.

The flash management unit 121 manages a total data size of write data corresponding to a plurality of received write commands for each zone. The flash management unit 121 also manages a total data size of write data stored in the HWB 1021.

Here, it is assumed that the HWB 1021 holds 8 KB of write data to be written to the zone #0, 16 KB of write data to be written to the zone #1, 512 KB of write data to be written to the zone #2, 16 KB of write data to be written to the zone #3, 16 KB of write data to be written to the zone #4, 8 KB of write data to be written to the zone #5, and 32 KB of write data to be written to the zone #6.

At this time, the total data size of the write data stored in the HWB 1021 is 608 KB. The free capacity of the HWB 1021 holding the write data of 608 KB is 416 KB.

At this time, the host 2 stores write data of 128 KB in the HWB 1021 in order to issue a write command designating writing of the write data of 128 KB in the zone #2.

As a result, a total data size of the write data to be written in the zone #2 stored in the HWB 1021 reaches 640 KB. When receiving the write command specifying writing of the write data of 128 KB to the zone #2, the flash management unit 121 calculates a total data size of write data corresponding to one or more received write commands specifying the zone #2. As a result, the flash management unit 121 recognizes that the total data size of the write data to be written in the zone #2 stored in the HWB 1021 has reached 640 KB. At this time, the flash management unit 121 executes a write operation for a QLC block #2 allocated to the zone #2.

When writing the write data of 640 KB, the flash management unit 121 can execute a foggy write operation of writing write data of 128 KB to a plurality of memory cells connected to each of five word lines among a plurality of word lines of a QLC block #2 and a fine write operation of writing the write data of 128 KB again to a plurality of memory cells connected to the first word line among the five word lines. As a result, the write data (128 KB), which is a part of the write data of 640 KB, becomes readable data. Thereafter, the flash management unit 121 transmits one or more completion responses to the one or more write commands corresponding to the data of 128 KB that has become readable to the host 2.

Then, the host 2 that has received the one or more completion responses releases a memory region of the HWB 1021 in which the write data associated with the received one or more completion responses is stored. As a result, the data size of the write data to be written to the zone #2 stored in the HWB 1021 becomes 512 KB.

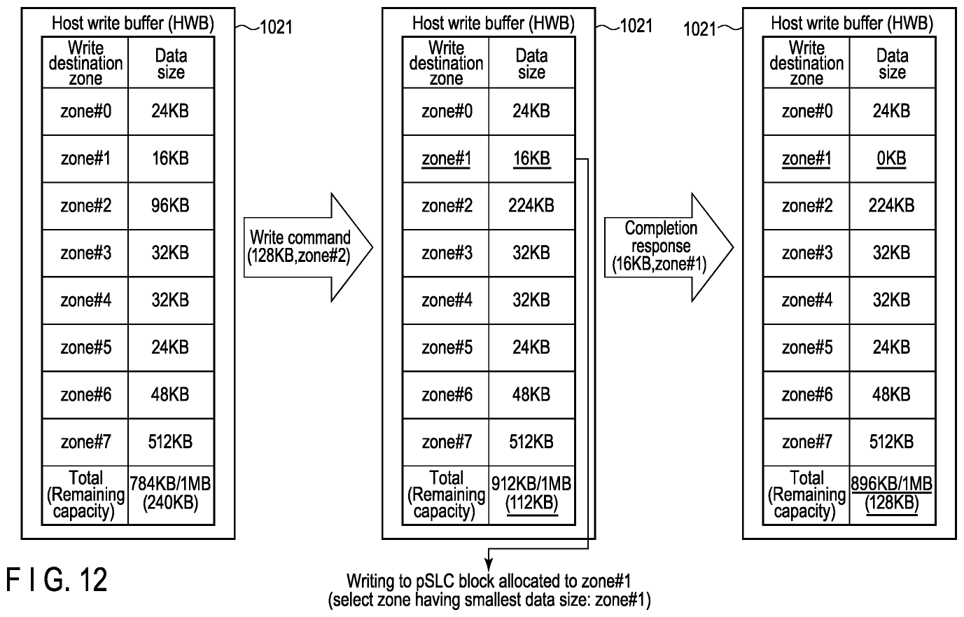

Next, an example of an operation of determining a zone in which write data is to be written to a pSLC block will be described. FIG. 12 is a diagram illustrating an operation of selecting a QLC block in which a total size of write data to be written thereto, stored in the host write buffer is smallest, an operation of writing data corresponding to the selected QLC block to a pSLC block, and an operation of transmitting the completion response to the host and releasing a memory region in the host write buffer, the operations being executed in the memory system according to the embodiment.

Similarly to FIG. 11, it is assumed that the memory system 3 manages eight zones (zone #0, zone #1, zone #2, zone #3, zone #4, zone #5, zone #6, and zone #7) and the capacity of the HWB 1021 is 1 MB (1024 KB).

The flash management unit 121 manages a total data size of write data corresponding to a plurality of received write commands for each zone. The flash management unit 121 also manages a total data size of write data stored in the HWB 1021.

Here, it is assumed that the HWB 1021 holds 24 KB of write data to be written to the zone #0, 16 KB of write data to be written to the zone #1, 96 KB of write data to be written to the zone #2, 32 KB of write data to be written to the zone #3, 32 KB of write data to be written to the zone #4, 24 KB of write data to be written to the zone #5, 48 KB of write data to be written to the zone #6, and 512 KB of write data to be written to the zone #7.

At this time, the total data size of the write data stored in the HWB 1021 is 784 KB. The free capacity of the HWB 1021 holding the write data of 784 KB is 240 KB.

At this time, the host 2 stores write data of 128 KB in the HWB 1021 in order to issue a write command designating writing of the write data of 128 KB in the zone #2.

As a result, a total data size of the write data to be written in the zone #2 stored in the HWB 1021 becomes 224 KB. At this time, a total data size of write data to be written in any zone does not reach 640 KB, but the remaining capacity of the HWB 1021 falls below 128 KB. Thus, the flash management unit 121 selects any one zone (for example, zone #1) as a write target zone in which write data is to be written in a pSLC block.

Here, the flash management unit 121 selects the zone #1 having the smallest data size of write data to be written, i.e., the zone #1 in which the total size of write data to be written thereto, stored in the HWB 1021 is smallest among the zones #0 to #7, as the write target zone.

Then, the flash management unit 121 allocates a pSLC block to the selected zone #1 and writes the write data of 16 KB to the allocated pSLC block. Alternatively, when a pSLC block has already been allocated to the selected zone #1, the flash management unit 121 writes the write data of 16 KB to the pSLC block that has been already allocated to the zone #1.

As a result, the written write data of 16 KB can be read from the NAND flash memory 5, and thus, the flash management unit 121 transmits one or more completion responses to one or more write commands corresponding to the written write data of 16 KB to the host 2.

In response to reception of the one or more completion responses, the host 2 releases a memory region of the HWB 1021 in which the write data related to the received one or more completion responses is stored. As a result, the data size of the write data to be written to the zone #1 stored in the HWB 1021 becomes 0 KB. The remaining capacity of the HWB 1021 becomes a value of 128 KB or more.

Since the zone having the smallest data size of the write data to be written is selected as the write target zone in this manner, the flash management unit 121 can select the zone to which the pSLC block is to be allocated while avoiding a zone having a high possibility of executing the operation of directly writing write data to the QLC block described in FIG. 11. As a result, the flash management unit 121 can increase the possibility of executing the operation of writing write data to the QLC block without passing through the pSLC block, and can more efficiently use the blocks of the NAND flash memory 5 by reducing the number of blocks used as the pSLC blocks.

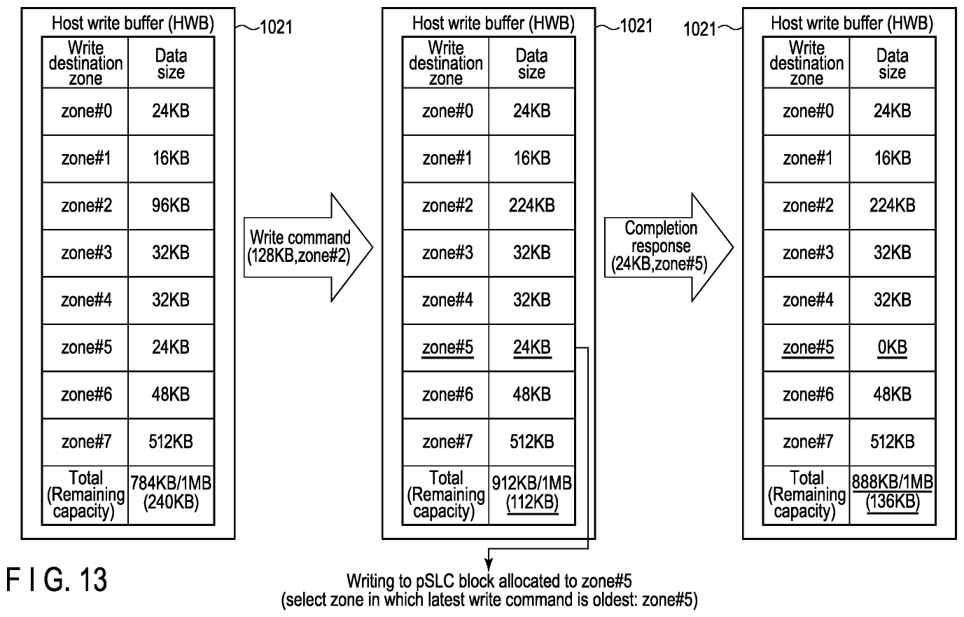

Next, another example of the operation of determining a zone in which write data is to be written in a pSLC block will be described. FIG. 13 is a diagram illustrating an operation of selecting a QLC block in which the latest write command specifying the QLC block has been received at the oldest time point, an operation of writing data corresponding to the selected QLC block to a pSLC block, and an operation of transmitting a completion response to the host and releasing a memory region in the host write buffer, the operations being executed in the memory system according to the embodiment.

Similarly to FIG. 11, it is assumed that the memory system 3 manages eight zones (zone #0, zone #1, zone #2, zone #3, zone #4, zone #5, zone #6, and zone #7) and the capacity of the HWB 1021 is 1 MB (1024 KB).

The flash management unit 121 manages a total data size of write data corresponding to a plurality of received write commands for each zone. The flash management unit 121 also manages a total data size of write data stored in the HWB 1021.

Here, it is assumed that the HWB 1021 holds 24 KB of write data to be written to the zone #0, 16 KB of write data to be written to the zone #1, 96 KB of write data to be written to the zone #2, 32 KB of write data to be written to the zone #3, 32 KB of write data to be written to the zone #4, 24 KB of write data to be written to the zone #5, 48 KB of write data to be written to the zone #6, and 512 KB of write data to be written to the zone #7.

At this time, the total data size of the write data stored in the HWB 1021 is 784 KB. The free capacity of the HWB 1021 holding the write data of 784 KB is 240 KB.

At this time, the host 2 stores write data of 128 KB in the HWB 1021 in order to issue a write command specifying writing of the write data of 128 KB to the zone #2.

As a result, a total data size of the write data to be written in the zone #2 stored in the HWB 1021 becomes 224 KB. At this time, a total data size of write data to be written to any zone does not reach 640 KB, but the remaining capacity of the HWB 1021 falls below 128 KB. Thus, the flash management unit 121 selects any one zone as a write target zone in which write data is to be written to a pSLC block.

Here, the flash management unit 121 selects the zone #5, which is a zone in which the latest write command specifying the zone has been received at the oldest time point, as the write target zone.

Then, the flash management unit 121 allocates a pSLC block to the selected zone #5 and writes the write data of 24 KB to the allocated pSLC block. Alternatively, when a pSLC block has already been allocated to the selected zone #5, the flash management unit 121 writes the write data of 24 KB to the pSLC block that has been already allocated to the zone #5.

As a result, the written write data of 24 KB can be read from the NAND flash memory 5, and thus, the flash management unit 121 transmits one or more completion responses to one or more write commands corresponding to the written write data of 24 KB to the host 2.

In response to reception of the one or more completion responses, the host 2 releases a memory region of the HWB 1021 in which the write data related to the received one or more completion responses is stored. As a result, the data size of the write data to be written to the zone #5 stored in the HWB 1021 becomes 0 KB. The remaining capacity of the HWB 1021 becomes a value of 128 KB or more.

Since the zone in which the latest write command specifying the zone has been received at the oldest time point is selected as the write target zone in this manner, the flash management unit 121 can select a zone in which the frequency of reception of the write command specifying the zone is low as the write target zone. Thus, the flash management unit 121 can select the zone to which the pSLC block is to be allocated while avoiding a zone having a high possibility of executing the operation of directly writing write data to the QLC block described with reference to FIG. 11, which is similar to the selection method described with reference to FIG. 12. As a result, the flash management unit 121 can increase the possibility of executing the operation of writing write data to the QLC block without passing through the pSLC block, and can more efficiently use the blocks of the NAND flash memory 5 by reducing the number of blocks used as the pSLC blocks.

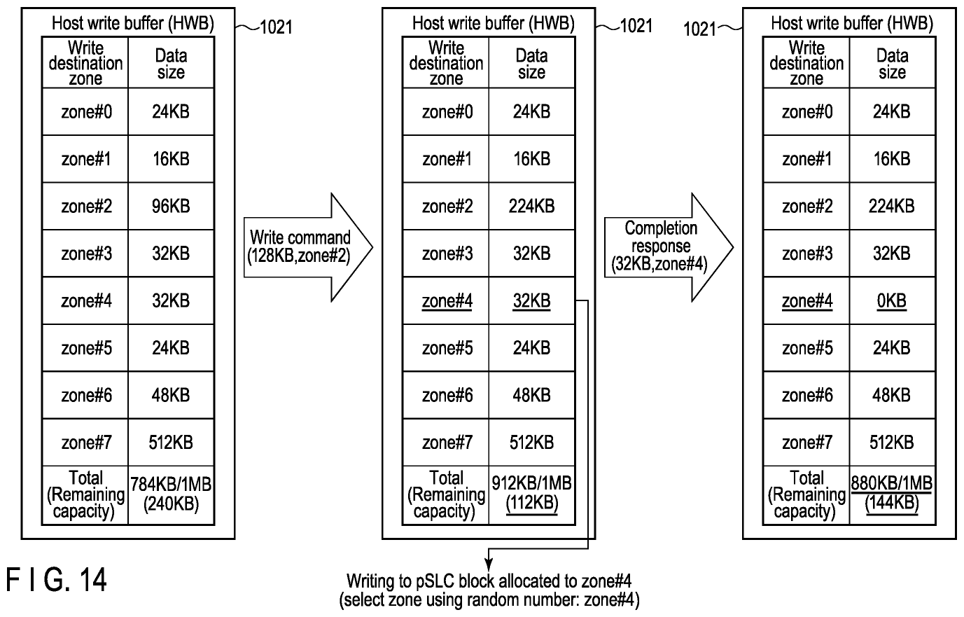

Next, still another example of the operation of determining a zone in which write data is to be written in a pSLC block will be described. FIG. 14 is a diagram illustrating an operation of selecting a QLC block using a random number, an operation of writing data corresponding to the selected QLC block to a pSLC block, and an operation of transmitting a completion response to the host and releasing a memory region in the host write buffer, the operations being executed in the memory system according to the embodiment.

Similarly to FIG. 11, it is assumed that the memory system 3 manages eight zones (zone #0, zone #1, zone #2, zone #3, zone #4, zone #5, zone #6, and zone #7) and the capacity of the HWB 1021 is 1 MB (1024 KB).

The flash management unit 121 manages a total data size of write data corresponding to a plurality of received write commands for each zone. The flash management unit 121 also manages a total data size of write data stored in the HWB 1021.

Here, it is assumed that the HWB 1021 holds 24 KB of write data to be written to the zone #0, 16 KB of write data to be written to the zone #1, 96 KB of write data to be written to the zone #2, 32 KB of write data to be written to the zone #3, 32 KB of write data to be written to the zone #4, 24 KB of write data to be written to the zone #5, 48 KB of write data to be written to the zone #6, and 512 KB of write data to be written to the zone #7.

At this time, the total data size of the write data stored in the HWB 1021 is 784 KB. The free capacity of the HWB 1021 holding the write data of 784 KB is 240 KB.

At this time, the host 2 stores write data of 128 KB in the HWB 1021 in order to issue a write command specifying writing of the write data of 128 KB to the zone #2.

As a result, a total data size of the write data to be written to the zone #2 stored in the HWB 1021 becomes 224 KB. At this time, a total data size of write data to be written to any zone does not reach 640 KB, but the remaining capacity of the HWB 1021 falls below 128 KB. Thus, the flash management unit 121 selects any one zone as a write target zone in which write data is to be written to a pSLC block.

Here, the flash management unit 121 generates a random number and selects the zone #4 as the write target zone using the generated random number. That is, the flash management unit 121 randomly selects the zone using the random number.

Then, the flash management unit 121 allocates a pSLC block to the selected zone #4 and writes the write data of 32 KB to the allocated pSLC block. Alternatively, when a pSLC block has already been allocated to the selected zone #4, the flash management unit 121 writes the write data of 32 KB to the pSLC block that has been already allocated to the zone #4.

As a result, the written write data of 32 KB can be read from the NAND flash memory 5, and thus, the flash management unit 121 transmits one or more completion responses to one or more write commands corresponding to the written write data of 32 KB to the host 2.

In response to reception of the one or more completion responses, the host 2 releases a memory region of the HWB 1021 in which the write data related to the received one or more completion responses is stored. As a result, the data size of the write data to be written in the zone #4 stored in the HWB 1021 becomes 0 KB. The remaining capacity of the HWB 1021 becomes a value of 128 KB or more.

Since the random number is generated and the write target zone is selected using the generated random number in this manner, the flash management unit 121 can select all the zones as the write target zones with equal probability in one selection operation. However, the frequency of exposure to the selection operation becomes higher in a zone having the lower frequency of reception of the write command since a period until the data size of the write data stored in the HWB 1021 reaches 640 KB increases. Thus, the tendency in which a zone is selected substantially equal to that in the selection method described in FIG. 13. Thus, the flash management unit 121 can select the zone to which the pSLC block is to be allocated while avoiding a zone having a high possibility of executing the operation of directly writing write data to the QLC block described with reference to FIG. 11. As a result, the flash management unit 121 can increase the possibility of executing the operation of writing write data to the QLC block without passing through the pSLC block, and can more efficiently use the blocks of the NAND flash memory 5 by reducing the number of blocks used as the pSLC blocks. In this selection method, it is unnecessary to refer to information such as the total data size of write data and the time point at which the latest write command has been received.

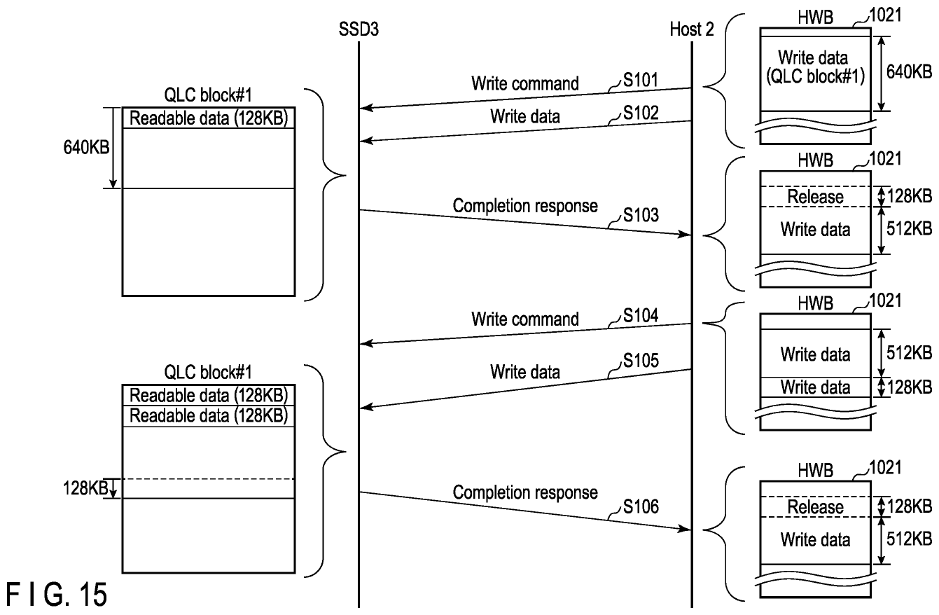

Next, a specific example of an interchange executed between the host 2 and the SSD 3 in a write operation for a QLC block will be described. FIG. 15 is a diagram illustrating a procedure of a write process with respect to a QLC block executed in the memory system according to the embodiment.

Here, the write operation for the QLC block #1 will be described.

First, the host 2 transmits one or more write commands specifying the QLC block #1 to the SSD 3 (step S101).

Each time a new write command specifying the QLC block #1 is received, the controller 4 of the SSD 3 calculates a total data size (total size) of write data to be written in the QLC block #1. When a new write command specifying the QLC block #1 is received and the total size of the write data to be written in the QLC block #1 reaches 640 KB, the controller 4 acquires 640 KB of the write data from the HWB 1021 (step S102). The controller 4 of the SSD 3 that has received the write data writes the write data of 640 KB to the QLC block #1. As a result, write data of 128 KB at the head of the written write data becomes readable data since fine writing is completed. Note that the controller 4 does not need to acquire the write data of 640 KB collectively from the HWB 1021, and may acquire write data from the host write buffer 2021 in units of the first minimum write unit (128 KB) in accordance with the progress of a foggy write operation for five word lines from the head of the QLC block #1. In this case, when the foggy write operation for the fifth word line of the QLC block #1 is finished, the controller 4 acquires write data of 128 KB, which is to be written to the head word line of the QLC block #1, from the HWB 1021 again. Then, the controller 4 executes the fine write operation for the head word line of the QLC block #1. Accordingly, writing to the head word line of the QLC block #1 is completed, and thus, the write data of 128 KB written in the head word line of the QLC block #1 becomes the readable data.

The controller 4 of the SSD 3 transmits one or more completion responses, which indicate completion of processing of the one or more write commands corresponding to the write data that has become the readable data, to the host 2 (step S103). In response to reception of the completion response, the host 2 releases a memory region of the HWB 1021 in which the write data corresponding to the received one or more completion responses is stored. As a result, the data size of the write data to be written in the QLC block #1 stored in the HWB 1021 becomes 512 KB.

Thereafter, the host 2 stores additional write data (128 KB), which is to be written in the QLC block #1, in the HWB 1021. The host 2 transmits, to the SSD 3, a new write command specifying writing of the added write data to the QLC block #1 (step S104).

The total size of the write data to be written in the QLC block #1 reaches 640 KB again. The controller 4 of the SSD 3 acquires 128 KB of the added write data, associated with the received new write command, from the HWB 1021 (step S105). The controller 4 executes a foggy write operation for the sixth word line of the QLC block #1. When the foggy write operation for the sixth word line is finished, the controller 4 acquires write data of 128 KB, which is to be written to the second word line of the QLC block #1, from the HWB 1021 again. Then, the controller 4 executes the fine write operation for the second word line of the QLC block #1. Accordingly, writing to the second word line of the QLC block #1 is completed, and thus, the write data of 128 KB written in the second word line of the QLC block #1 becomes the readable data.

The controller 4 of the SSD 3 transmits a completion response, which indicate completion of processing of the write command corresponding to the write data that has become the readable data, to the host 2 (step S106). In response to reception of the completion response, the host 2 releases a memory region of the HWB 1021 in which the write data corresponding to the received completion response is stored. As a result, the data size of the write data to be written to the QLC block #1 stored in the HWB 1021 becomes 512 KB.

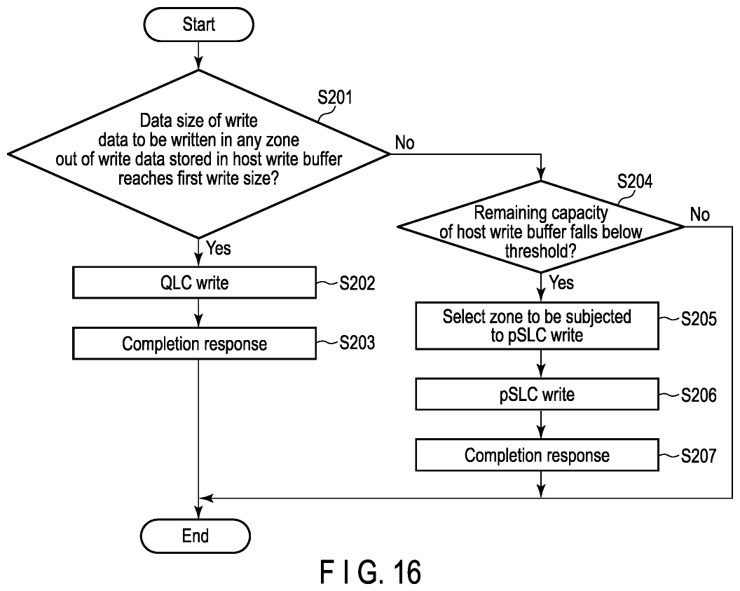

Next, a procedure of a write control process executed in the SSD 3 will be described. FIG. 16 is a flowchart illustrating the procedure of the write control process executed in the memory system according to the embodiment.

The controller 4 starts the write control process in response to reception of a write command from the host 2.

First, the controller 4 determines whether a data size of write data to be written to any zone among write data stored in the host write buffer (HWB) 1021 has reached the first write size (step S201).

When the data size of the write data to be written to any one of the zones among the write data stored in the host write buffer (HWB) 1021 reaches the first write size (Yes in step S201), the controller 4 selects this zone and executes a write operation for a QLC block (step S202). The controller 4 writes the write data to the QLC block allocated to the selected zone in which the write data having the data size reaching the first write size is to be written thereto.

The controller 4 transmits one or more completion responses to one or more write commands corresponding to the write data that has become readable data in the process of step S202 to the host 2, and causes the host 2 to release a memory region of the HWB 1021 in which the write data that has become the readable data is stored (step S203). Then, the controller 4 finishes the write control process.

On the other hand, when the data size of the write data to be written to any zone among the write data stored in the host write buffer (HWB) 1021 has not reached the first write size (No in step S201), the controller 4 determines whether the remaining capacity of the HWB 1021 falls below a threshold (step S204). For example, the controller 4 uses 128 KB as the threshold.

When the remaining capacity of the HWB 1021 does not fall below the threshold (No in step S204), the controller 4 finishes the write control process.

When the remaining capacity of the HWB 1021 falls below the threshold (Yes in step S204), the controller 4 selects a zone that is to be subjected to pSLC write (step S205). The controller 4 selects a zone in which the data size of write data that is to be written thereto is smallest, as a target zone. Alternatively, the controller 4 selects a zone in which the latest write command specifying the zone has been received at the oldest time point, as the target zone. The controller 4 may select the target zone using a random number.

Then, the controller 4 writes the write data to a pSLC block allocated to the zone selected in step S205 (step S206).

The controller 4 transmits one or more completion responses to one or more write commands corresponding to the write data written in the pSLC block in step S206 to the host 2, and causes the host 2 to release a memory region of the HWB 1021 in which the write data written in the pSLC block is stored (step S207).

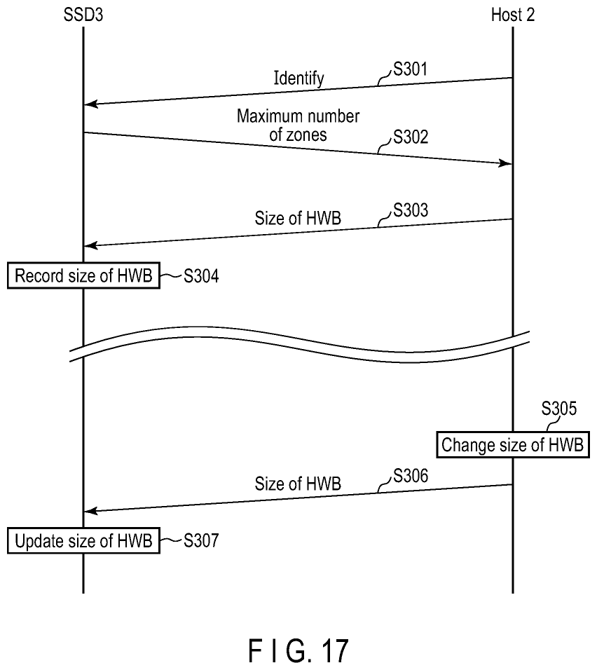

Next, a process for managing a size of the HWB 1021 executed between the memory system 3 and the host 2 will be described. FIG. 17 is a sequence diagram illustrating a procedure of the process of managing the size of the host write buffer based on a notification from the host executed in the memory system according to the embodiment.

First, the host 2 transmits Identify command to the SSD 3 (step S301). The Identify command is a command for requesting information necessary for initialization process of the SSD 3.

The SSD 3 transmits the maximum number of zones supported by the SSD 3 to the host 2 as a response to the Identify command received in step S301 (step S302).

Then, the host 2 notifies the SSD 3 of a size of a memory region available as the HWB 1021 (step S303).

When receiving the notification in step S303, the SSD 3 records the received size of the HWB 1021 (step S304). As a result, the SSD 3 can calculate a size of the remaining region of the HWB 1021 from the recorded size of the HWB 1021 and the information indicating the data size included in the received write command.

When the host 2 changes the size of the memory region available as the HWB 1021 (step S305), the host 2 notifies the SSD 3 of the changed size of the HWB 1021 (step S306).

When receiving the notification in step S306, the SSD 3 records the received size of the HWB 1021 (step S307).

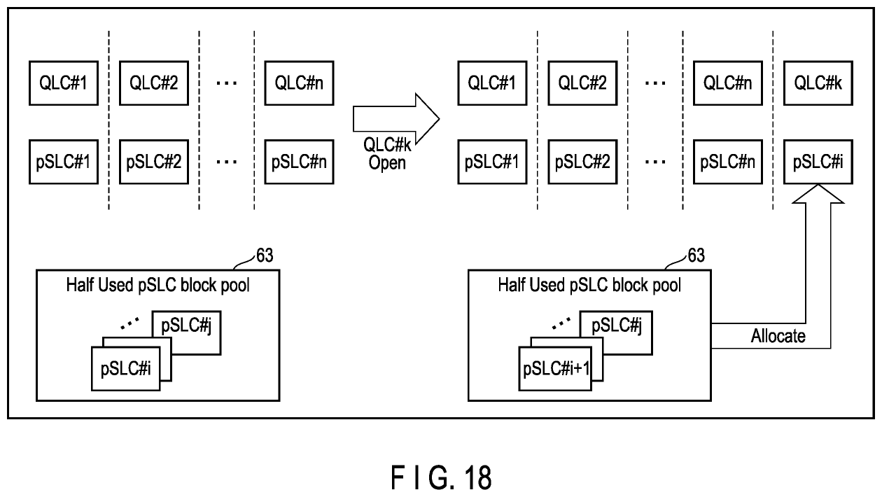

Next, details of allocation of a pSLC block to a QLC block will be described. FIG. 18 is a diagram illustrating a pSLC block allocated to each of a plurality of QLC blocks in the memory system according to the embodiment.

In FIG. 18, n QLC blocks (QLC #1, QLC #2, . . . , and QLC #n) are opened as write destination blocks. Further, n pSLC blocks (pSLC #1, pSLC #2, . . . , and pSLC #n) are allocated to the n QLC blocks (QLC #1, QLC #2, . . . , and QLC #n).

In the left part of FIG. 18, pSLC #1 is allocated to QLC #1, pSLC #2 is allocated to QLC #2, and pSLC #n is allocated to QLC #n.

An identifier of a pSLC block that can be newly allocated to a QLC block is stored in the Half Used pSLC block pool 63. The Half Used pSLC block pool 63 is used to manage each of Half Used pSLC blocks including a written region in which write-completed data is stored and an unwritten region. The Half Used pSLC block pool 63 includes a pSLC block that has been selected from the free pSLC block pool 62 and then erased, and a pSLC block deallocated from a QLC block in a state including the unwritten region. Here, the Half Used pSLC block pool 63 includes pSLC blocks pSLC #i, . . . , and pSLC #j.

When a new QLC block (here, QLC #k) is opened as the write destination block, the pSLC block control unit 123 selects any pSLC block (here, pSLC #i) from the Half Used pSLC block pool 63. Then, the pSLC block control unit 123 allocates the selected pSLC #i to QLC #k. Further, in a case where there is no available pSLC block in the Half Used pSLC block pool 63 when the new QLC block is opened, the pSLC block control unit 123 may select any pSLC block from the free pSLC block pool 62. The pSLC block control unit 123 executes an erase operation for the selected pSLC block, and manages the selected pSLC block as a Half Used pSLC block using the Half Used pSLC block pool 63. Alternatively, the pSLC block control unit 123 may execute the erase operation for the selected pSLC block, and directly allocate the selected pSLC block to QLC #k without passing through the Half Used pSLC block pool 63.

Accordingly, pSLC #i is allocated to QLC #k as a dedicated write buffer for QLC #k. In this case, data to be written in another QLC block is not written in pSLC #i, and only data to be written in QLC #k is written in pSLC #i.

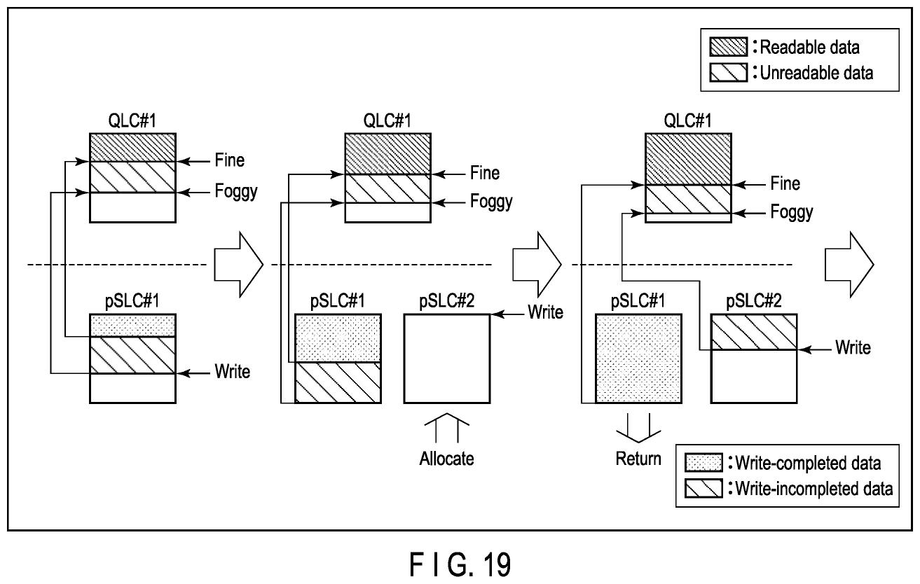

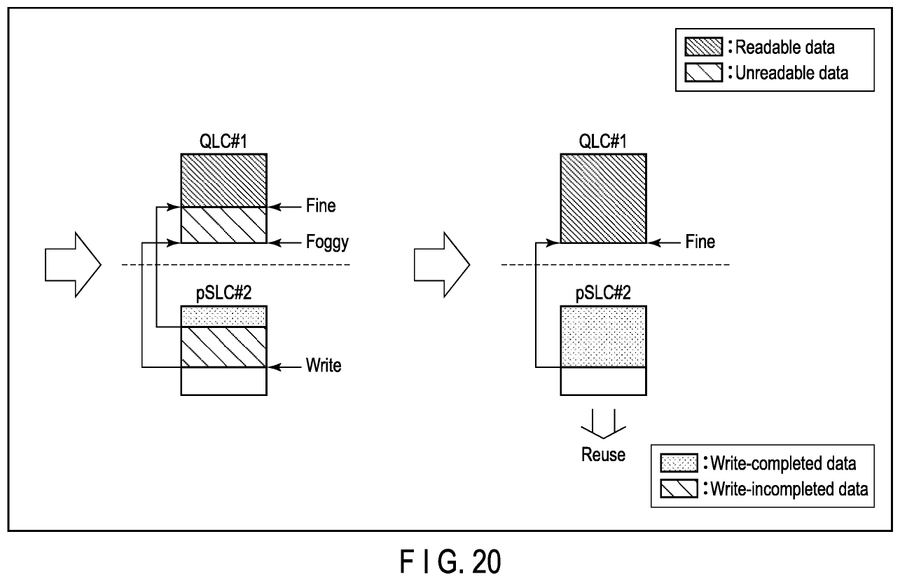

Next, a specific write operation and deallocation of a pSLC block will be described with reference to FIGS. 19 and 20. FIG. 19 is a first diagram for describing a write operation for a certain QLC block executed in the memory system according to the embodiment. In FIG. 19, writing of data to QLC #1 and pSLC #1 allocated to QLC #1 will be described.

Among pieces of data written in QLC #1, data, a fine write operation of which has been completed, is readable data. In addition, among pieces of the data written in QLC #1, data, a foggy write operation of which has been completed, but the fine write operation of which has not been completed, is unreadable data. Among storage regions of QLC #1, a storage region in which no data is written is an unwritten region.

Among pieces of data written in pSLC #1, data, the fine write operation for QLC #1 of which has been completed, is write-completed data. Among pieces of the data written in pSLC #1, data, the fine write operation for QLC #1 of which has not been completed, is write-incompleted data. Among storage regions of pSLC #1, a storage region in which no data is written is an unwritten region.

When a fine write operation for a certain word line of QLC #1 becomes executable, the flash management unit 121 executes the fine write operation for QLC #1 using the write-incompleted data stored in pSLC #1. The write-incompleted data is data that has been already used for a foggy write operation for the word line of QLC #1. Then, when the fine write operation for the word line is completed, the data in pSLC #1 that has been used for the fine write operation becomes the write-completed data.

The flash management unit 121 writes data to be written in QLC #1 to the pSLC block #1 until there is no unwritten region in pSLC #1. The data of pSLC #1, the fine write operation for QLC #1 of which has been completed, becomes the write-completed data. When there is no more unwritten region in pSLC #1, the pSLC block control unit 123 allocates a new pSLC block (here, pSLC #2) to QLC #1. Here, the pSLC block control unit 123 selects any pSLC block from the Half Used pSLC block pool 63, and allocates the selected pSLC block to QLC #1. In addition, when the Half Used pSLC block pool 63 has no pSLC block available for writing, the pSLC block control unit 123 selects any free pSLC block from the free pSLC block pool 62, and allocates the selected free pSLC block to QLC #1. Here, a case where the pSLC block control unit 123 newly allocates pSLC #2 having no write-completed data to QLC #2 is assumed.

The pSLC block control unit 123 may select pSLC #2 from the free pSLC block pool 62, execute an erase operation for pSLC #2, then move pSLC #2 to the Half Used pSLC block pool 63, and allocate pSLC #2 to QLC #1, or may execute the erase operation for pSLC #2 and then directly allocate pSLC #2 to QLC #1.

Next, the flash management unit 121 writes the data to be written to QLC #1 to pSLC #2 as write-uncompleted data. The flash management unit 121 executes the foggy write operation for QLC #1 using the data written in pSLC #2. Then, when the fine write operation becomes executable in response to the execution of the foggy write operation, the flash management unit 121 executes the fine write operation for QLC #1. As the fine write operation for QLC #1 is executed, a part of the write-incompleted data in pSLC #1 becomes the write-completed data. When the entire data stored in pSLC #1 becomes the write-completed data, the pSLC block control unit 123 deallocates pSLC #1 from QLC #1 and returns pSLC #1 to the free pSLC block pool 62.

Next, a subsequent operation will be described with reference to FIG. 20. The flash management unit 121 executes the foggy write operation for QLC #1 until there is no unwritten region in QLC #1. Then, when the fine write operation becomes executable in response to the execution of the foggy write operation, the flash management unit 121 executes the fine write operation for QLC #1.

Next, the flash management unit 121 executes the remaining fine write operation for QLC #1. When the fine write operation for all the word lines of QLC #1 is completed, QLC #1 is filled with the data, writing of which to QLC #1 has been completed. As a result, the entire data in QLC #1 becomes the readable data. Then, all pieces of the write-incompleted data in pSLC #2 become the write-completed data.

At this time, pSLC #2 includes the unwritten region and does not include the write-incompleted data. Thus, even if write-uncompleted data to be written to a write destination QLC block other than QLC #1 is written to the unwritten region of pSLC #2, the write-uncompleted data to be written to a different QLC block is not mixed in pSLC #2. The pSLC block control unit 123 deallocates pSLC #2 from QLC #1, and returns pSLC #2 to the Half Used pSLC block pool 63.

As a result, for example, when a new QLC block is opened, pSLC #2 is reused to be allocated to the QLC block as a write buffer. When pSLC #2 is selected to be allocated to the QLC block, pSLC #2 is allocated to the QLC block without executing an erase operation. Then, the flash management unit 121 writes the data to be written to this QLC block to the remaining unwritten region of pSLC #2.

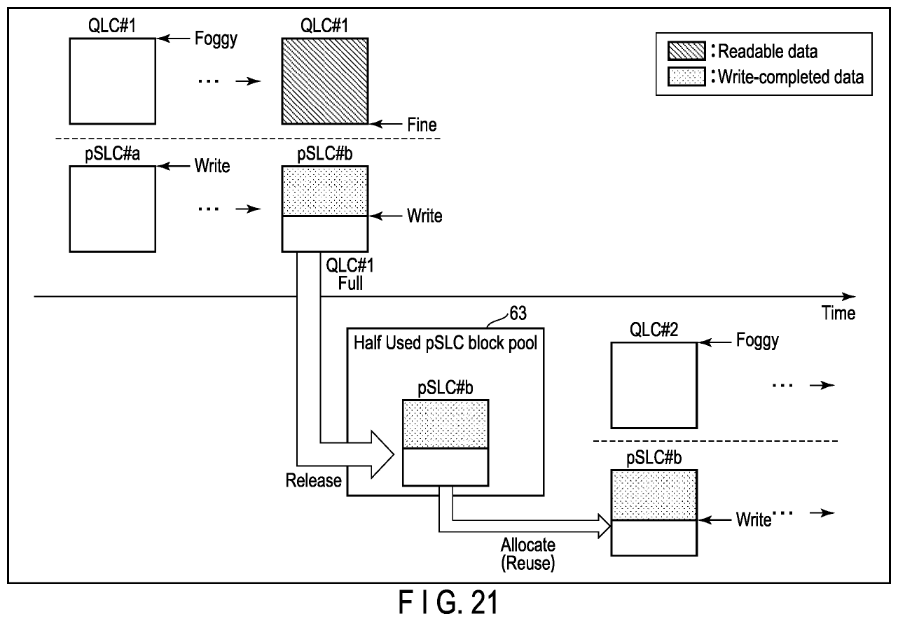

Next, reuse of a pSLC block will be described. FIG. 21 is a diagram illustrating a pSLC block that is reused by being allocated to another QLC block after allocation to a certain QLC block is released in the memory system according to the embodiment.

First, when QLC #1 is opened, the pSLC block control unit 123 allocates pSLC #a to QLC #1. Then, the flash management unit 121 executes a write operation for QLC #1 and pSLC #a similarly to the operation described with reference to FIGS. 19 and 20.

When there is no more unwritten region in pSLC #a, the pSLC block control unit 123 allocates a new pSLC to QLC #1. When there is no more unwritten region in the new pSLC, the pSLC block control unit 123 further allocates a new pSLC to QLC #1. In this manner, the pSLC block control unit 123 sequentially allocates some pSLCs to QLC #1 while returning the pSLC filled with the write-completed data to the free pSLC block pool 62 in accordance with the progress of writing to QLC #1. For example, when pSLC #b is allocated to QLC #1, data to be written in QLC #1 is written in pSLC #b. Then, when writing to QLC #1 progresses so that the entire data in QLC #1 becomes the readable data, the entire data in pSLC #b also becomes the write-completed data. At this time, when there is an unwritten region in pSLC #b, the pSLC block control unit 123 deallocates pSLC #b from QLC #1. Then, the pSLC block control unit 123 returns pSLC #b to the Half Used pSLC block pool 63.

Thereafter, when a QLC block QLC #2 is newly opened, the pSLC block control unit 123 selects pSLC #b in the Half Used pSLC block pool 63, and allocates pSLC #b to QLC #2. Then, the flash management unit 121 writes data to be written to QLC #2 to the unwritten region of pSLC #b.

As a result, the controller 4 can allocate pSLC #b, which has been allocated to QLC #1 and used, to the newly opened QLC #2 and reuse pSLC #b. In addition, even if pSLC #b is allocated to QLC #2 and the data to be written to QLC #2 is written to pSLC #b, the entire data related to QLC #1 remaining in pSLC #b is the write-completed data, and thus, the write-incompleted data, which is to be written to a different QLC block, is not mixed in pSLC #b.

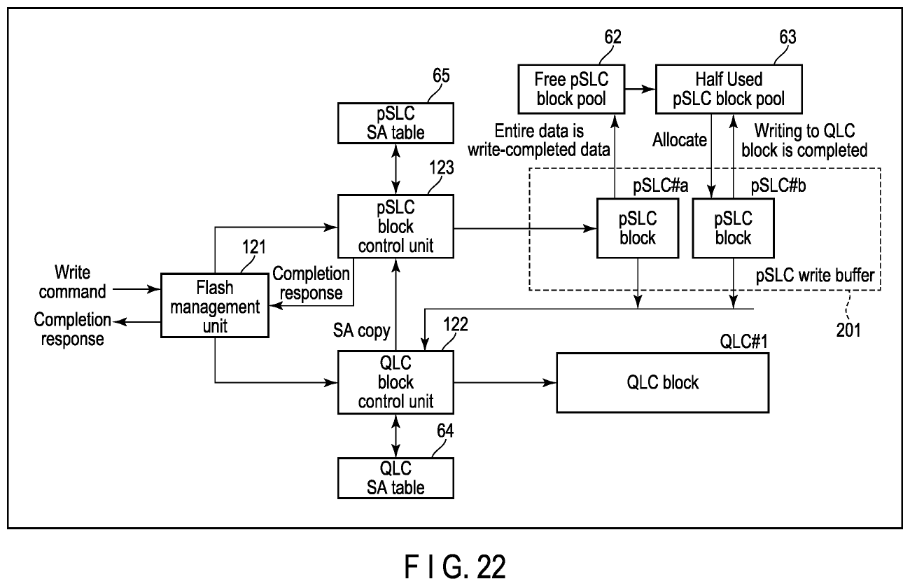

FIG. 22 is a diagram illustrating a relationship between a certain QLC block and a plurality of pSLC blocks allocated to the QLC block in the memory system according to the embodiment. A relationship between QLC #1 and a plurality of pSLC blocks allocated to QLC #1 will be described hereinafter.

When a write command specifying QLC #1 is received from the host 2, the flash management unit 121 first notifies the QLC block control unit 122 of information regarding the received write command, for example, a size of data associated with the received write command, information indicating a position in the host write buffer 1021 where the data is stored, and the like.

The QLC block control unit 122 updates the QLC SA table 64 based on the received information on the write command. The QLC SA table 64 is used to hold a plurality of source addresses SA. Each of the plurality of source addresses SA indicates a position where data to be written to QLC #1 is stored. The QLC block control unit 122 stores, in the QLC SA table 64, information indicating a position in the host write buffer 1021 in which data associated with the write command is stored as the source address SA.

When a total size of data associated with one or more received write commands specifying QLC #1 reaches the second minimum write size, the flash management unit 121 updates the pSLC SA table 65 of the pSLC block control unit 123 by copying all the source addresses SA stored in the QLC SA table 64 to the pSLC SA table 65. Each of the source addresses SA of the pSLC SA table 65 indicates a position where data to be written in a pSLC block, which has been allocated to QLC #1, is stored.

The flash management unit 121 acquires the data associated with the one or more received write commands, that is, the data having the second minimum write size to be written in QLC #1 from the host write buffer 1021 based on each of the source addresses SA of the pSLC SA table 65. Then, the flash management unit 121 writes the acquired data to the pSLC block (here, pSLC #a).

When the data is written to pSLC #a, the flash management unit 121 transmits one or more completion responses indicating completion of the one or more write commands corresponding to the data to the host 2.

When the data having the second minimum write size is written to pSLC #a, the flash management unit 121 updates the QLC SA table 64 such that each of the source addresses SA of the data to be written in QLC #1 is changed from the position in the host write buffer 1021 to the position in pSLC #a in which the data has been written.

At this time, when a read command specifying the data as read target data is received from the host 2, the flash management unit 121 reads the read target data from pSLC #a based on the source address SA corresponding to the read target data and transmits the read target data to the host 2. Before the data is written in pSLC #a, the source address SA corresponding to the data indicates the position in the host write buffer 1021. Therefore, the flash management unit 121 reads the read target data from the host write buffer 1021 based on the source address SA corresponding to the read target data if the read command specifying the data as read target data is received from the host 2 before the data is written in pSLC #a, and transmits the read target data to the host 2.

When a total size of data written in pSLC #a reaches the first minimum write size, the flash management unit 121 reads data having the first minimum write size to be written to QLC #1 from pSLC #a based on each of the source addresses SA of the QLC SA table 64. Then, the flash management unit 121 writes the read data to QLC #1 by a foggy write operation.

When writing to QLC #1 proceeds and a fine write operation for a certain word line in QLC #1 can be executed, the flash management unit 121 reads data, which is to be written to this word line, again from pSLC #a. Then, the flash management unit 121 writes the read data to QLC #1 by the fine write operation.

As such an operation is repeated, there is no more unwritten region in pSLC #a eventually. In this case, the pSLC block control unit 123 selects any pSLC block (here, pSLC #b) from the Half Used pSLC block pool 63, and allocates the selected pSLC #b to QLC #1.

When the entire data written in pSLC #a becomes the write-completed data, the pSLC block control unit 123 returns pSLC #a to the free pSLC block pool 62.

When the entire QLC #1 is filled with the data, writing of which to QLC #1 has been completed, that is, the readable data in a state where pSLC #b is allocated to QLC #1, the pSLC block control unit 123 returns pSLC #b to the Half Used pSLC block pool 63.

With the above operation, the host 2 can release a memory region in the host write buffer 1021 storing data associated with a write command related to a completion response at the timing of receiving the completion response. Since the controller 4 transmits the completion response to the host 2 for each piece of the data having the minimum write size of the pSLC block, which is smaller than the minimum write size of the QLC block, the required size of the host write buffer 1021 can be reduced as compared with a case where the completion response is transmitted to the host 2 after completion of writing of the data corresponding to the minimum write size of the QLC block.

Here, the number of times of data transfer executed between the NAND flash memory 5 and the controller 4 will be considered.

When the write operation described with reference to FIG. 22 is executed, five times of data transfer are required: (1) data transfer from the controller 4 to the NAND flash memory 5, which is executed to write data to the pSLC block; (2) data transfer from the NAND flash memory 5 to the controller 4, which is executed to read data from the pSLC block for foggy writing; (3) data transfer from the controller 4 to the NAND flash memory 5, which is executed to write data to the QLC block for foggy writing; (4) data transfer from the NAND flash memory 5 to the controller 4, which is executed to read data from the pSLC block for fine writing; and (5) data transfer from the controller 4 to the NAND flash memory 5, which is executed to write data for fine writing.

When the data written in the pSLC block is used for a write operation for the QLC block, the controller 4 needs to read the data from the pSLC block in order to perform error correction on the data written in the pSLC block. Thus, the data transfer between the controller 4 and the NAND flash memory 5 is performed twice during the foggy writing and the fine writing.

Thus, a bandwidth, which is five times of a bandwidth in a case where write data is transferred from the controller 4 to the NAND flash memory 5 only once, is used.

In the SSD 3 of the present embodiment, the temporary write buffer (TWB) 161 in the SRAM 16 and the large write buffer (LWB) 66 in the DRAM 6 are used in order to reduce the bandwidth to be consumed.

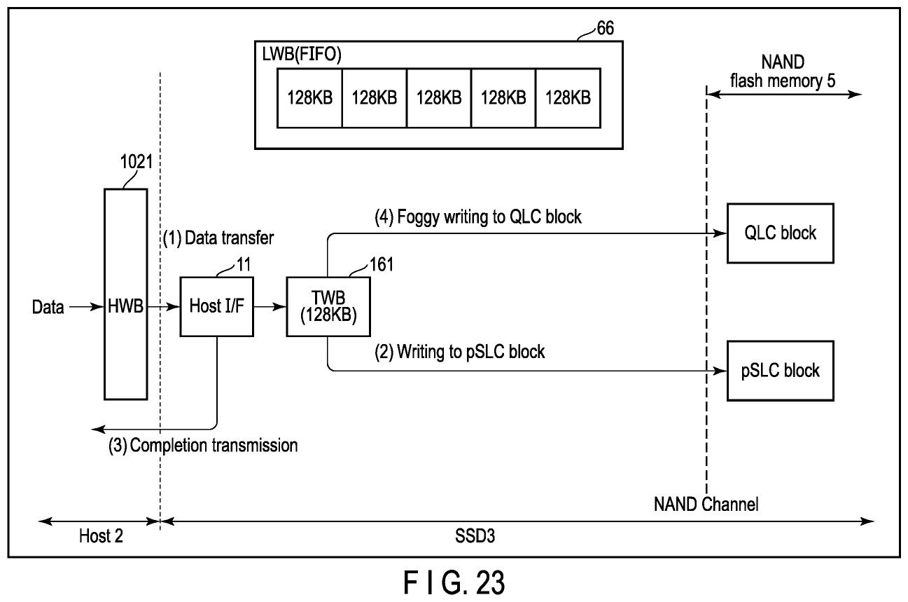

FIG. 23 is a diagram illustrating a foggy write operation using the TWB in the memory system according to the embodiment. The foggy write operation using the TWB is executed only for a write destination QLC block which is determined to write corresponding write data to a pSLC block before execution of the foggy write operation.

(1) The flash management unit 121 calculates a total size of write data associated with one or more received write commands specifying a certain QLC block. The flash management unit 121 waits until the total size of the write data associated with the one or more received write commands specifying the QLC block reaches the first minimum write size. When the total size of the write data associated with the one or more received write commands specifying the QLC block reaches the first minimum write size, the flash management unit 121 transfers the write data having the first minimum write size associated with the one or more write commands from the host write buffer 1021 to the TWB 161 through the host interface 11.

The TWB 161 holds the data to be written to the QLC block until the foggy write operation for the QLC block is completed. A size of a memory region of the TWB 161 is, for example, the same as the minimum write size (first minimum write size) of the QLC block (for example, 128 KB).

(2) The controller 4 executes a write operation for the pSLC block by transferring the data having the first minimum write size, which has been transferred to the TWB 161, to the pSLC block.

(3) In response to completion of the write operation for the pSLC, the controller 4 transmits one or more completion responses to the one or more write commands to the host 2 through the host interface 11. The data written in the pSLC block is data that is already readable. Thus, the controller 4 can transmit the completion response.

(4) The controller 4 executes foggy writing with respect to the QLC block by transferring the data having the first minimum write size, which has been transferred to the TWB 161, to the QLC block. Thereafter, the controller 4 releases a memory region of the TWB 161 in response to the completion of this foggy write operation.

Since the TWB 161 is used, the controller 4 can execute the foggy write operation for the QLC block which is determined to write the corresponding write data to the pSLC block without reading the data stored in the pSLC block as described above. As a result, the number of times of data transfer required to be executed between the controller 4 and the NAND flash memory 5 can be reduced.

In order to further reduce the number of times of data transfer required to be executed between the controller 4 and the NAND flash memory 5, the SSD 3 can use the large write buffer (LWB) 66. The LWB 66 is a first-in-first-out (FIFO) volatile memory in which each entry has a memory region having the same size as the TWB 161. Here, the LWB 66 has five entries. The number of entries in the LWB 66 is determined such that a QLC block can store data of a size that enables execution of a fine write operation. For example, in a case where the SSD 3 executes a foggy-fine write operation of reciprocating between two word lines, the LWB 66 may have two entries. In addition, in a case where the SSD 3 executes a foggy-fine write operation of reciprocating among five word lines, the LWB 66 may have five entries.

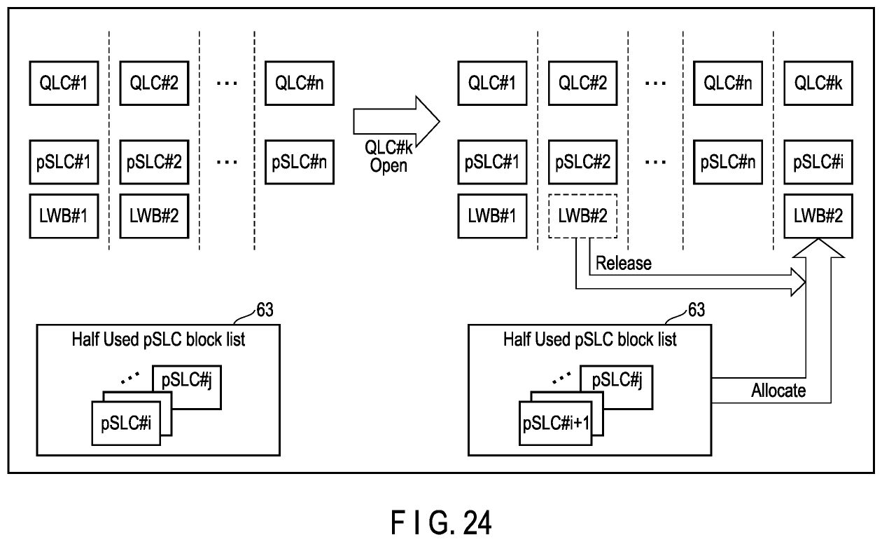

Next, an operation of allocating the LWB 66 to a QLC block will be described. FIG. 24 is a diagram illustrating a pSLC block and a LWB allocated to each of a plurality of QLC blocks in the memory system according to the embodiment.

In FIG. 24, the QLC blocks QLC #1, QLC #2, . . . , and QLC #n are opened and allocated to zones, respectively. Further, pSLC blocks are allocated to the QLC blocks, respectively.

In the left part of FIG. 24, pSLC #1 is allocated to QLC #1, pSLC #2 is allocated to QLC #2, and pSLC #n is allocated to QLC #n.

Further, there is a pSLC block, which can be newly allocated to a QLC block, in the Half Used pSLC block pool 63. The Half Used pSLC block pool 63 includes a pSLC block that has been selected from the free pSLC block pool 62 and then erased, and a pSLC block deallocated from a QLC block in a state including the unwritten region. Here, the Half Used pSLC block pool 63 includes pSLC blocks pSLC #i, . . . , and pSLC #j.

Further, the LWB 66 includes a large write buffer LWB #1 and a large write buffer LWB #2. LWB #1 is allocated to QLC #1, and LWB #2 is allocated to QLC #2.

When a QLC block QLC #k is newly opened, the pSLC block control unit 123 selects any pSLC block (pSLC #i) from the Half Used pSLC block pool 63. Then, the pSLC block control unit 123 allocates the selected pSLC #i to QLC #k.

Then, the controller 4 selects any LWB between LWB #1 and LWB #2. For example, the controller 4 may select LWB in which the latest data has been written thereto at an older timing (here, LWB #2). Then, the controller 4 deallocates LWB #2 from QLC #2, and allocates LWB #2 to the newly opened QLC #k. As a result, the controller 4 can preferentially allocate the LWB 66 to the newly opened QLC block.

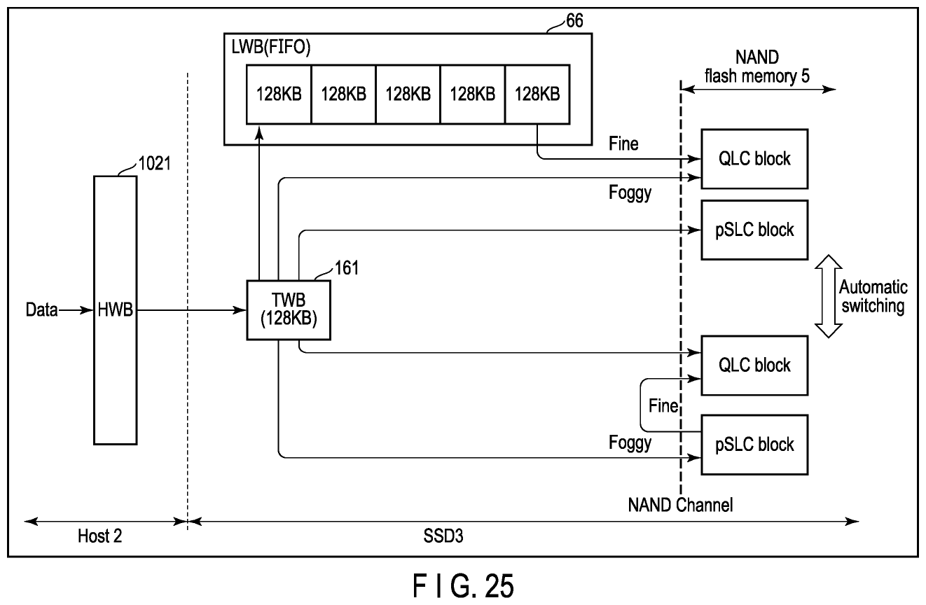

FIG. 25 is a diagram illustrating switching between two types of write operations executed in the memory system according to the embodiment. The upper part of FIG. 25 illustrates foggy-fine writing with respect to a QLC block to which LWB 66 is allocated, and the lower part of FIG. 25 illustrates foggy-fine writing with respect to a QLC block from which LWB 66 has been deallocated.

When data to be written to the QLC block to which the LWB 66 is allocated is stored in the TWB 161, the controller 4 copies the data to be written to the QLC block from the TWB 161 to the LWB 66 after completing a foggy write operation for the QLC block. When a fine write operation for the QLC block becomes executable, the controller 4 executes the fine write operation for the QLC block using the data stored in the LWB 66. Thus, the QLC block to which the LWB 66 is allocated does not need to read data from a pSLC block at the time of executing not only the foggy write operation but also the fine write operation. Thus, the consumption of a bandwidth between the controller 4 and the NAND flash memory 5 is further reduced as compared with a QLC block to which the LWB 66 is not allocated.

It is unnecessary for the LWB 66 to be allocated to all opened QLC blocks. In the QLC block from which the LWB 66 has been deallocated as in QLC #2 in FIG. 24, the controller 4 executes a fine write operation for the QLC block using data read from a pSLC block.

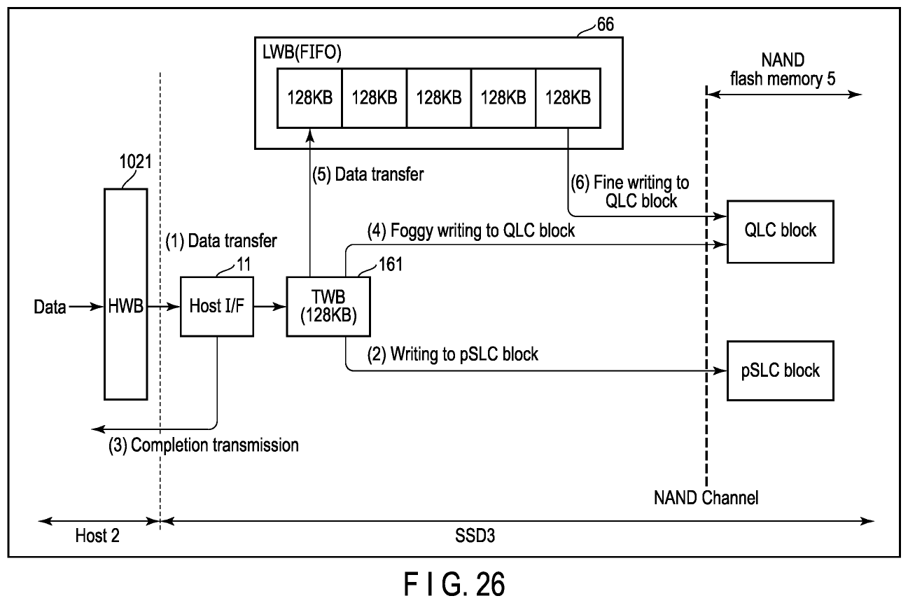

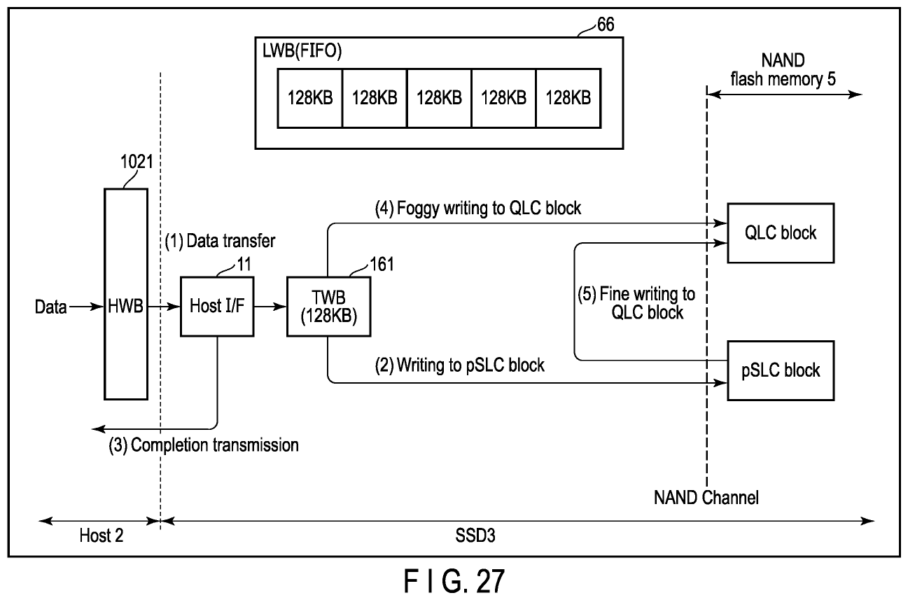

The controller 4 executes a foggy-fine write operation illustrated in FIG. 26 or 27 depending on whether the LWB 66 is allocated to a QLC block specified by a write command.

First, details of the foggy-fine write operation for the QLC block to which the LWB 66 is allocated will be described. FIG. 26 is a diagram illustrating a write operation executed using the TWB and the LWB in the memory system according to the embodiment.

(1) The controller 4 receives one or more write commands specifying a certain QLC block from the host 2 through the host interface 11. When a total size of data associated with the one or more write commands specifying the certain QLC block reaches the minimum write size (first minimum write size) of the QLC block, the controller 4 transfers data having the first minimum write size from the host write buffer 1021 to the TWB 161 through the host interface 11.

(2) The controller 4 executes a write operation for the pSLC block by transferring the data having the first minimum write size, which has been transferred to the TWB 161, to the pSLC block.

(3) In response to completion of the write operation for the pSLC, the controller 4 transmits one or more completion responses to the one or more write commands to the host 2 through the host interface 11. The data written in the pSLC block is data that is already readable. Thus, the controller 4 can transmit the completion response.

(4) The controller 4 executes a foggy write operation to the QLC block by transferring the data having the first minimum write size, which has been transferred to the TWB 161, to the QLC block.

(5) When the foggy write operation is completed, the controller 4 copies the data having the first minimum write size from the TWB 161 to the LWB 66. Thereafter, the controller 4 releases the memory region of the TWB 161 in response to completion of copying of data to the LWB 66.

The controller 4 repeats the above operations of (1) to (5).

(6) When a fine write operation becomes executable, the controller 4 executes the fine write operation for the QLC block using the data stored in the LWB 66.

Next, details of the foggy-fine write operation for the QLC block to which the LWB 66 is not allocated will be described. FIG. 27 is a diagram illustrating a write operation executed using the TWB in the memory system according to the embodiment.

(1) The controller 4 receives one or more write commands specifying a certain QLC block from the host 2 through the host interface 11. When a total size of data associated with the one or more write commands specifying the certain QLC block reaches the minimum write size (first minimum write size) of the QLC block, the controller 4 transfers data having the first minimum write size from the host write buffer 1021 to the TWB 161 through the host interface 11.

(2) The controller 4 executes a write operation for the pSLC block by transferring the data having the first minimum write size, which has been transferred to the TWB 161, to the pSLC block.

(3) In response to completion of the write operation for the pSLC, the controller 4 transmits one or more completion responses to the one or more write commands to the host 2 through the host interface 11. The data written in the pSLC block is data that is already readable. Thus, the controller 4 can transmit the completion response.

(4) The controller 4 executes a foggy write operation to the QLC block by transferring the data having the first minimum write size, which has been transferred to the TWB 161, to the QLC block. Thereafter, the controller 4 releases a memory region of the TWB 161 in response to completion of foggy writing with respect to the QLC block.

The controller 4 repeats the above operations of (1) to (4).

(5) The controller 4 reads data from the pSLC block when fine writing becomes executable. Then, the controller 4 executes the fine write operation for the QLC block using the read data.

Thereafter, the controller 4 sets the data, fine writing of which has been completed, among pieces of data written in the pSLC block as write-completed data.

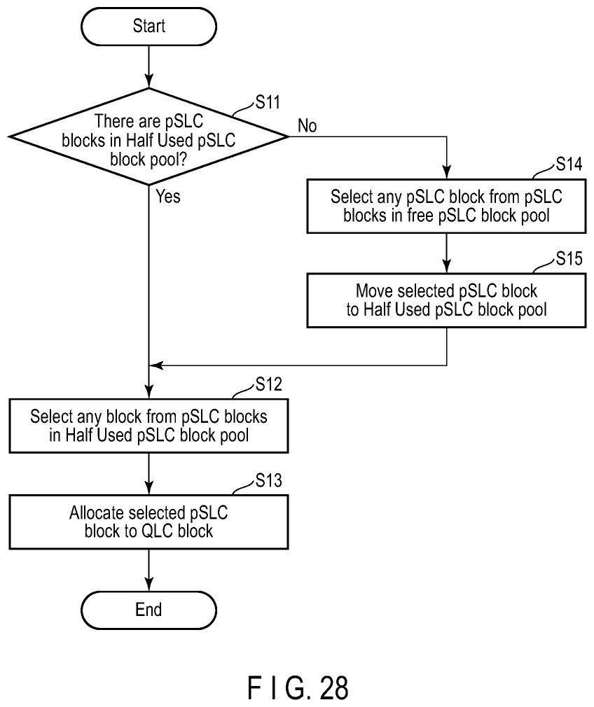

Next, a procedure of an operation of allocating a pSLC block to a QLC block will be described. FIG. 28 is a flowchart illustrating the procedure of the operation of allocating the pSLC block to the QLC block executed in the memory system according to the embodiment.

When any QLC block is opened or when there is no more unwritten region in a pSLC block allocated to any QLC block, the controller 4 starts the operation of allocating the pSLC block to the QLC block.

First, the controller 4 determines whether there are pSLC blocks in the Half Used pSLC block pool 63 (step S11).

When there are pSLC blocks in the Half Used pSLC block pool 63 (Yes in step S11), the controller 4 selects any pSLC block from the pSLC blocks existing in the Half Used pSLC block pool 63 (step S12). In consideration of wear leveling, the controller 4 may select the pSLC blocks in the Half Used pSLC block pool 63 such that consumption levels of all the pSLC blocks are almost the same.

The controller 4 allocates the pSLC block selected in step S12 to the QLC block (step S13).

When there is no pSLC block in the Half Used pSLC block pool 63 (No in step S11), the controller 4 selects any pSLC block from pSLC blocks existing in the free pSLC block pool 62 (step S14). The controller 4 may select the pSLC block in the free pSLC block pool 62 in consideration of wear leveling.

The controller 4 moves the pSLC block selected in step S14 to the Half Used pSLC block pool 63 (step S15). The controller 4 executes an erase operation for the pSLC block selected in step S14. Then, the controller 4 adds the pSLC block to a list of the Half Used pSLC block pool 63, thereby executing the operation in step S15.

Then, the controller 4 selects any pSLC block from pSLC blocks existing in the Half Used pSLC block pool 63 (step S12). That is, the controller 4 selects the pSLC block moved to the Half Used pSLC block pool 63 in step S15.

The controller 4 allocates the pSLC block selected in step S12 (step S14) to the QLC block (step S13).

As a result, the controller 4 preferentially allocates the pSLC block existing in the Half Used pSLC block pool 63 to the QLC block at the time of allocating the pSLC block to the QLC block. When there is no pSLC block in the Half Used pSLC block pool 63, the controller 4 selects a pSLC block from the free pSLC block pool 62, and allocates the pSLC block to the QLC block through the Half Used pSLC block pool 63. In addition, the controller 4 may directly allocate the pSLC block existing in the free pSLC block pool 62 to the QLC block without passing through the Half Used pSLC block pool 63.

As described above, according to the present embodiment, when the total size of the write data associated with the one or more received write commands specifying any write destination QLC block reaches the first write size (for example, 640 KB), the write data to be written to the write destination QLC block are directly written to the write destination QLC block without passing through the pSLC block. In addition, when the remaining capacity of the host write buffer 1021 falls below the threshold since a plurality of pieces of write data, which are to be written to different write destination blocks, each having the total size smaller than the first write size are stored in the host write buffer 1021, one write destination block from among the different write destination blocks is selected, and write data corresponding to the selected write destination block is written to the pSLC block in units of the second minimum write size.

Therefore, writing to the QLC block and writing to the pSLC block are selectively executed such that write data for the QLC block having the larger amount of writing by the host 2 is directly written to the write destination QLC block. Therefore, data can be efficiently written to the plurality of write destination QLC blocks without increasing the size of required nonvolatile write buffers (pSLC buffers).

In addition, the controller 4 allocates the pSLC block (for example, pSLC #1) included in the pSLC buffer 201 to the QLC block (for example, QLC #1) included in the QLC region 202. The controller 4 writes only data, which is to be written in QLC #1, to pSLC #1. Then, the controller 4 does not write data, which is to be written in a QLC block other than QLC #1, to pSLC #1 while pSLC #1 is allocated to QLC #1.

As a result, a situation in which pieces of write-incompleted data to be written in a plurality of QLC blocks are mixed in pSLC #1 is not likely to occur. The controller 4 can efficiently operate the pSLC block without executing garbage collection processing on the pSLC buffer 201 including pSLC #1.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory system connectable to a host including a memory, the memory system comprising:
a nonvolatile memory including a plurality of blocks, each of the plurality of blocks being a unit for a data erase operation; and
a controller electrically connected to the nonvolatile memory and configured to manage a first set of blocks among the plurality of blocks and a second set of blocks among the plurality of blocks and control writing of data to a plurality of write destination blocks allocated from the first set of blocks, each block in the first set of blocks having a first minimum write size, each block in the second set of blocks having a second minimum write size smaller than the first minimum write size, wherein
the controller is configured to:
receive, from the host, a plurality of write commands each of which specifies any one of the plurality of write destination blocks;
when a total size of write data associated with one or more received write commands which specify one write destination block among the plurality of write destination blocks reaches a first write size that enables completion of writing of data having the first minimum write size to the one write destination block, execute a write operation for the one write destination block such that writing of write data having the first minimum write size to the one write destination block is completed, the write data having the first minimum write size being among pieces of write data stored in a write buffer of the memory in the host, and cause the host to release a region of the write buffer storing the write data written to the one write destination block, wherein the first write size is an integral multiple of the first minimum write size; and
when a plurality of pieces of write data, which are to be written to different write destination blocks, each having a total size smaller than the first write size are stored in the write buffer and a remaining capacity of the write buffer falls below a threshold, select a write destination block from among the different write destination blocks, write, to a second block included in the second set of blocks, write data corresponding to the selected write destination block in units of the second minimum write size, and cause the host to release a region of the write buffer storing the write data written to the second block.

2. The memory system according to claim 1, wherein
the controller is configured to:
write, using a first write mode in which reading of data written to one word line among a plurality of word lines included in the one write destination block is enabled after writing of data to one or more word lines subsequent to the one word line, data having the first minimum write size to a plurality of memory cells connected to each word line of the one write destination block; and
write, using a second write mode in which reading of data written to one word line among a plurality of word lines included in the second block is enabled by writing of data to the one word line of the second block, data having the second minimum write size to a plurality of memory cells connected to each word line of the second block.

3. The memory system according to claim 1, wherein
the controller is configured to:
when the remaining capacity of the write buffer falls below the threshold, select, from among the different write destination blocks, a write destination block in which a total size of write data to be written thereto, stored in the write buffer is smallest among the different write destination blocks.

4. The memory system according to claim 1, wherein
the controller is configured to:
when the remaining capacity of the write buffer falls below the threshold, select, from among the different write destination blocks, a write destination block in which a latest write command specifying the write destination block has been received at an oldest time point.

5. The memory system according to claim 1, wherein
the controller is configured to:
when the remaining capacity of the write buffer falls below the threshold, select one write destination block from among the different write destination blocks using a random number.

6. The memory system according to claim 1, wherein
the threshold is a value determined based on the first minimum write size.

7. The memory system according to claim 1, wherein
the controller is configured to:
calculate a total size of write data, writing of which has not been completed, among the pieces of write data associated with the plurality of write commands already received from the host, and calculate the remaining capacity of the write buffer by subtracting the calculated total size of write data, writing of which has not been completed, from a capacity of the write buffer.

8. The memory system according to claim 7, wherein
the controller is configured to:
receive a notification specifying an available capacity of the write buffer from the host; and
manage the available capacity specified by the received notification as the capacity of the write buffer.

9. The memory system according to claim 8, wherein
the controller is configured to:
in response to receiving, from the host, a change request for changing the available capacity of the write buffer to a new capacity, change the managed capacity of the write buffer to the new capacity.

10. The memory system according to claim 1, wherein
the controller is configured to:
when first write data, which is to be written to a first write destination block among the plurality of write destination blocks, is written in the second block and a total size of the first write data written in the second block reaches the first minimum write size, read the first write data from the second block, and write the read first write data to the first write destination block.

11. The memory system according to claim 1, wherein
the controller is configured to:
allocate one second block among a plurality of blocks, included in the second set of blocks, to the selected one write destination block, and write only the write data corresponding to the selected one write destination block to the one second block allocated to the selected one write destination block.

12. A method of managing a first set of blocks among a plurality of blocks included in a nonvolatile memory and a second set of blocks among the plurality of blocks, each block in the first set of blocks having a first minimum write size, each block in the second set of blocks having a second minimum write size smaller than the first minimum write size, the method comprising:
receiving, from a host including a memory, a plurality of write commands each of which specifies any one of a plurality of write destination blocks allocated from the first set of blocks;
when a total size of write data associated with one or more received write commands which specify one write destination block among the plurality of write destination blocks reaches a first write size that enables completion of writing of data having the first minimum write size to the one write destination block, executing a write operation for the one write destination block such that writing of write data having the first minimum write size to the one write destination block is completed, the write data having the first minimum write size being among pieces of write data stored in a write buffer of the memory in the host, and causing the host to release a region of the write buffer storing the write data written to the one write destination block, wherein the first write size is an integral multiple of the first minimum write size; and
when a plurality of pieces of write data, which are to be written to different write destination blocks, each having a total size smaller than the first write size are stored in the write buffer and a remaining capacity of the write buffer falls below a threshold, selecting a write destination block from among the different write destination blocks, writing, to a second block included in the second set of blocks, write data corresponding to the selected write destination block in units of the second minimum write size, and causing the host to release a region of the write buffer storing the write data written to the second block.

13. The method according to claim 12, wherein
the writing to the write destination block is executed using a first write mode in which reading of data written to one word line among a plurality of word lines included in the write destination block is enabled after writing of data to one or more word lines subsequent to the one word line, and
the writing to the second block is executed using a second write mode in which reading of data written in one word line among a plurality of word lines included in the second block is enabled by writing of data to the one word line of the second block.

14. The method according to claim 12, further comprising:
when the remaining capacity of the write buffer falls below the threshold, selecting, from among the different write destination blocks, a write destination block in which a total size of write data to be written thereto, stored in the write buffer is smallest among the different write destination blocks.

15. The method according to claim 12, further comprising:
when the remaining capacity of the write buffer falls below the threshold, selecting, from among the different write destination blocks, a write destination block in which a latest write command specifying the write destination block has been received at an oldest time point.

16. The method according to claim 12, further comprising:
when the remaining capacity of the write buffer falls below the threshold, selecting one write destination block from among the different write destination blocks using a random number.

17. The method according to claim 12, wherein
the threshold is a value determined based on the first minimum write size.

18. The method according to claim 12, further comprising:
calculating a total size of write data, writing of which has not been completed, among the pieces of write data associated with the plurality of write commands already received from the host, and calculating the remaining capacity of the write buffer by subtracting the calculated total size of write data, writing of which has not been completed, from a capacity of the write buffer.

19. The method according to claim 12, further comprising:
receiving a notification specifying an available capacity of the write buffer from the host; and
managing the available capacity specified by the received notification as the capacity of the write buffer.

20. The method according to claim 19, further comprising:
in response to receiving, from the host, a change request for changing the available capacity of the write buffer to a new capacity, changing the managed capacity of the write buffer to the new capacity.
